(19) United States
(12) Patent Application Publication
(10) Pub. No.: US 2026/0085154 A1
(43) Pub. Date: Mar. 26, 2026

(54) POLYMER, COMPOSITION, CURED PRODUCT, LAMINATED BODY, AND ELECTRONIC COMPONENT

(71) Applicant: JSR CORPORATION, Tokyo (JP)

(72) Inventors: Naoyuki KAWASHIMA, Minato-ku, Tokyo (JP); Eri SATONAKA, Minato-ku, Tokyo (JP); Shoma ANABUKI, Minato-ku, Tokyo (JP)

(73) Assignee: JSR CORPORATION, Tokyo (JP)

(21) Appl. No.: 19/109,248

(22) PCT Filed: Jul. 31, 2023
(86) PCT No.: PCT/JP2023/027900

§ 371 Date: Mar. 6, 2025

(30) Foreign Application Priority Data
Sep. 9, 2022 (JP) 2022-143851
Oct. 21, 2022 (JP) 2022-169094

(51) Int. Cl. C08G 65/40; B32B 15/20; C08F 290/06; C08K 5/13; C08K 5/14

(52) U.S. Cl. CPC C08G 65/4037; B32B 15/20; C08F 290/062; C08K 5/13; C08K 5/14; B32B 2250/02; B32B 2255/06; B32B 2255/26; B32B 2307/206; B32B 2457/08; B32B 2457/14; B32B 2457/20; C08G 2150/00; C08G 2650/20

(57) ABSTRACT

A polymer (A) includes a repeating structural unit represented by formula (1). R¹¹ represents a divalent substituted or unsubstituted nitrogen-containing heteroaromatic ring; R¹²'s independently represent a divalent substituted or unsubstituted aromatic hydrocarbon group; R¹³ represents a hydrocarbon group having 1 to 20 carbon atoms to which at least one group represented by formula (a1) is bonded in addition to two R¹²'s; X¹'s independently represent —O—, —S—, or —N(R¹⁴)—; and R¹⁴ is a hydrogen atom, a monovalent hydrocarbon group having 1 to 20 carbon atoms, a monovalent halogenated hydrocarbon group having 1 to 20 carbon atoms, or a group in which the hydrocarbon group or the halogenated hydrocarbon group is partially substituted with an oxygen atom, a sulfur atom, or both. In formula (a1), * represents a linkage to the R¹³; ** represents a bond to another structural unit in the polymer (A).

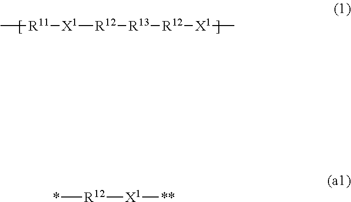

### TECHNICAL FIELD

One embodiment of the present invention relates to a polymer, a composition, a cured product, a laminated body, or an electronic component.

### BACKGROUND ART

In recent years, in the field of information communication, a signal band of an information communication device has been increased in frequency for the purpose of high-speed and large-capacity transmission. In order to cope with this high frequency, there is an increasing demand for a low dielectric/low dissipation factor material also for an insulator used for a printed wiring board or a semiconductor package. In addition, since the insulator is in contact with, for example, a metal wire of, for example, copper, it is desired that the insulator material has an expansion (linear expansion coefficient) due to heat generation during conduction close to that of a metal type of, for example, a wire.

As a material corresponding to the high frequency, for example, a composition using a polyolefin resin, a styrene resin, a fluororesin, a polyphenylene ether resin, a vinyl benzyl ether resin, or a polyphenylene ether resin has been proposed (Patent Literatures 1 to 6).

### CITATION LIST

### Patent Literature

Patent Literature 1: JP H07-188362 A
Patent Literature 2: JP 2004-83680 A
Patent Literature 3: JP 3414556 B2
Patent Literature 4: JP 2003-306591 A
Patent Literature 5: JP 5649773 B2
Patent Literature 6: JP 2017-200997 A

### SUMMARY OF INVENTION

### Technical Problem

However, the conventional materials such as the compositions described in Patent Literatures 1 to 6 are excellent in low dielectric/low dissipation factor to some extent, but do not necessarily satisfy all requirements for properties required for electronic materials such as heat resistance and adhesiveness.

For example, a composition using a polyphenylene ether resin and a fluororesin are excellent in low dielectric/low dissipation factor and heat resistance, but do not have sufficient adhesiveness to a copper foil with low roughness, and has a large difference in linear expansion coefficient from copper. In addition, when a copper wire is formed, for example, disconnection or connection failure may occur due to a difference in linear expansion coefficient from copper. Therefore, in general, there is a method using an inorganic filler together in order to reduce the difference in linear expansion coefficient, but there is a problem that adhesion to a copper wire is reduced when the addition amount is too large. As described above, it is difficult to balance various physical properties in a composition or a fluororesin using a polyphenylene ether resin. In addition, the composition described in Patent Literature 6 has room for improvement in terms of low dielectric properties.

One object of the present invention is to provide a polymer that has a low permittivity and a low dissipation factor, and to provide a composition and a laminated body that have a low permittivity and a low dissipation factor and are excellent in curability, adhesiveness, heat resistance, and linear expansion coefficient in a well-balanced manner.

### Solution to Problem

The present inventor has conducted intensive studies in order to solve the above problems, and as a result, has found that the above problems can be solved by the following configuration examples. The configuration examples of the present invention are as follows.

[1]

A polymer (A) having a repeating structural unit represented by a formula (1) below:

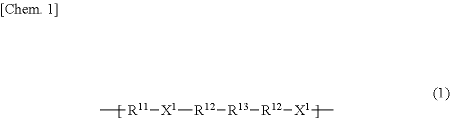

in the formula (1),
R¹¹ represents a divalent substituted or unsubstituted nitrogen-containing heteroaromatic ring,
R¹²'s independently represent a divalent substituted or unsubstituted aromatic hydrocarbon group,
R¹³ represents a hydrocarbon group having 1 to 20 carbon atoms to which at least one group represented by a formula (a1) below is bonded in addition to two R¹²'s,
X¹'s independently represent —O—, —S—, or —N(R¹⁴)—, and
R¹⁴ is a hydrogen atom, a monovalent hydrocarbon group having 1 to 20 carbon atoms, a monovalent halogenated hydrocarbon group having 1 to 20 carbon atoms, or a group in which the hydrocarbon group or the halogenated hydrocarbon group is partially substituted with at least one selected from an oxygen atom and a sulfur atom,

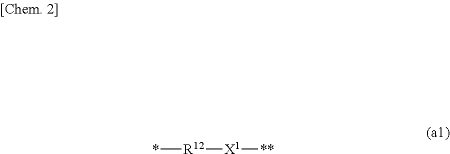

in the formula (a1),
* represents a linkage to the R¹³,
** represents a bond to another structural unit in the polymer (A), and
R¹² and X¹ have the same meaning as R¹² and X¹ in the formula (1), respectively.
   [2]

The polymer (A) according to item [1], further having a repeating structural unit represented by a formula (2) below:

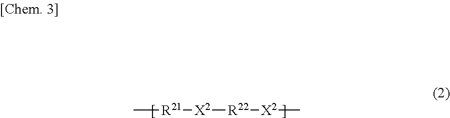

in the formula (2),
R²¹ represents a divalent substituted or unsubstituted nitrogen-containing heteroaromatic ring,
R²² represents a divalent group containing a substituted or unsubstituted aromatic hydrocarbon group in a main chain,
X²'s independently represent —O—, —S—, or —N(R²⁴)—, and
R²⁴ is a hydrogen atom, a monovalent hydrocarbon group having 1 to 20 carbon atoms, a monovalent halogenated hydrocarbon group having 1 to 20 carbon atoms, or a group in which the hydrocarbon group or the halogenated hydrocarbon group is partially substituted with at least one selected from an oxygen atom and a sulfur atom.
   [3]

The polymer (A) according to items [1] or [2], having a group Y represented by a formula (y) below at a terminal:

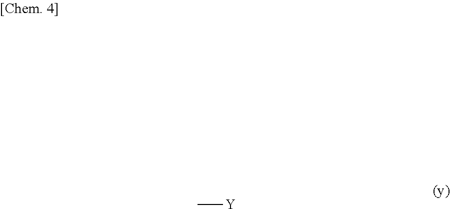

in the formula (y), Y represents a group containing an ethylenically unsaturated double bond and having 3 to 50 carbon atoms, a substituted or unsubstituted aromatic hydrocarbon group having 6 to 50 carbon atoms, a substituted or unsubstituted aliphatic hydrocarbon group having 6 to 50 carbon atoms, or an unsubstituted nitrogen-containing heteroaromatic ring.
   [4]

The polymer (A) according to any one of items [1] to [3], wherein when all structural units contained in the polymer (A) are taken as 100 mol %, the repeating structural unit represented by the formula (1) is contained in a range of 5 mol % or more and 95 mol % or less.

[5]

The polymer (A) according to any one of items [1] to [4], wherein —R¹²-'s in the formulae (1) and (a1) are independently a structure represented by a formula (5) below:

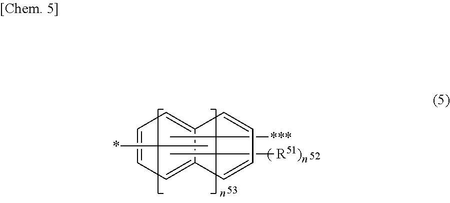

in the formula (5),
* represents a linkage to the R¹³,
*** represents a bond to the X¹, and
R⁵¹ represents an alkyl group having 1 to 10 carbon atoms, an alkoxy group having 1 to 10 carbon atoms, or a cycloalkyl group having 3 to 10 carbon atoms, n⁵² represents an integer of 0 to 4, and n⁵³ represents an integer of 0 to 2.
   [6]

The polymer (A) according to item [5], wherein the structure represented by the formula (5) is a formula (5-1) below or a formula (5-2) below:

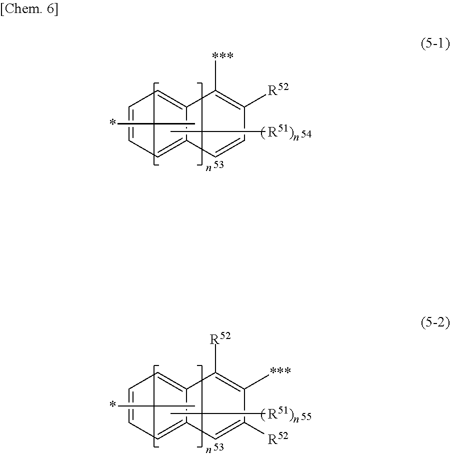

in the formulae (5-1) and (5-2),
* represents a linkage to the R¹³,
*** represents a bond to the X¹,
R⁵¹ and n⁵³ have the same meaning as R⁵¹ and n⁵³ in the formula (5),
n⁵⁴ represents an integer of 0 to 3, and n⁵⁵ represents an integer of 0 to 2; and
R⁵² represents an alkyl group having 1 to 10 carbon atoms, an alkoxy group having 1 to 10 carbon atoms, or a cycloalkyl group having 3 to 10 carbon atoms.
   [7]

A composition comprising the polymer (A) according to any one of items [1] to [6] and a curable compound (B) other than the polymer (A).

[8]

The composition according to item [7], wherein the curable compound (B) contains at least one selected from a group consisting of a vinyl compound, a maleimide compound, an allyl compound, an acrylic compound, a methacrylic compound, a thiol compound, an oxazine compound, a cyanate compound, an epoxy compound, an oxetane compound, a methylol compound, a benzocyclobutene compound, a propargyl compound, and a silane compound.

[9]

The composition according to items [7] or [8], further comprising at least one selected from a group consisting of a hindered phenolic compound, a phosphorus-based compound, a sulfur-based compound, a metal-based compound, and a hindered amine-based compound.

[10]

A composition containing a polymer (A2) having a repeating structural unit represented by a formula (3) below and a repeating structural unit represented by a formula (4) below, and a curable compound (B2) other than the polymer (A2):

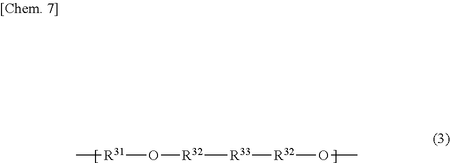

in the formula (3),
R³¹ represents a divalent organic group having 3 to 10 carbon atoms,
R³²'s independently represent a divalent substituted or unsubstituted aromatic hydrocarbon group, and
R³³ represents a hydrocarbon group having 1 to 20 carbon atoms to which two R¹²'s and at least one group represented by a formula (a2) below are bonded,

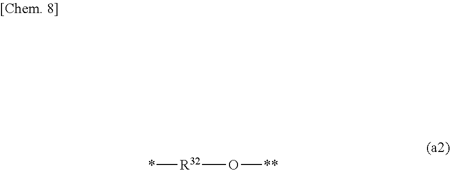

in the formula (a2),
* represents a linkage to the R³³,
** represents a bond to another structural unit in the polymer (A2), and
R³² has the same meaning as R³² in the formula (3),

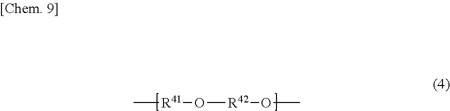

in the formula (4),
R⁴¹ represents a divalent organic group having 3 to 10 carbon atoms, and
R⁴² represents a divalent group containing a substituted or unsubstituted aromatic hydrocarbon group in a main chain, and an oxygen atom in the formula is directly bonded to the aromatic hydrocarbon group.
   [11]

The composition according to item [10], wherein the polymer (A2) has a group Y represented by a formula (y) below at a terminal:

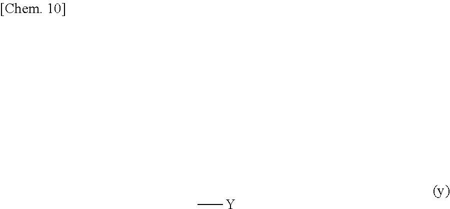

in the formula (y), Y represents a group containing an ethylenically unsaturated double bond and having 3 to 50 carbon atoms, a substituted or unsubstituted aromatic hydrocarbon group having 6 to 50 carbon atoms, a substituted or unsubstituted aliphatic hydrocarbon group having 6 to 50 carbon atoms, or an unsubstituted nitrogen-containing heteroaromatic ring.
   [12]

The composition according to items or [11], wherein the curable compound (B2) contains at least one selected from a group consisting of a vinyl compound, a maleimide compound, an allyl compound, an acrylic compound, a methacrylic compound, a thiol compound, an oxazine compound, a cyanate compound, an epoxy compound, an oxetane compound, a methylol compound, a benzocyclobutene compound, a propargyl compound, and a silane compound.

[13]

The composition according to any one of items to [12], further comprising an antioxidant.

[14]

A cured product which is a cured body of the composition according to any one of items [7] to [13].

[15]

A laminated body comprising a substrate and a cured product layer formed using the composition according to any one of items [7] to [13].

An electronic component comprising the cured product according to item [14].

[17]

An electronic component comprising the laminated body according to item [15].

### Advantageous Effects of Invention

According to one embodiment of the present invention, it is possible to provide a polymer that has a low permittivity and a low dissipation factor, and it is possible to obtain a composition and a laminated body that have a low permittivity and a low dissipation factor and are excellent in curability, adhesiveness, heat resistance, and linear expansion coefficient in a well-balanced manner.

### DESCRIPTION OF EMBODIMENTS

Hereinafter, preferred embodiments according to the present invention will be described in detail. It should be understood that the present invention is not limited only to embodiments described below, but also includes various modifications performed without changing the gist of the present invention.

In the present description, a numerical range described using “to” means that the numerical values described before and after “to” are included as a lower limit value and an upper limit value.

Hereinafter, a polymer, a composition, a cured product, a laminated body, or an electronic component according to one embodiment of the present invention will be described in detail.

### <<Polymer>>

A polymer according to one embodiment of the present invention (hereinafter also referred to as “polymer (A)”) has a repeating structural unit represented by the following formula (1) (hereinafter also referred to as “repeating unit (1)”).

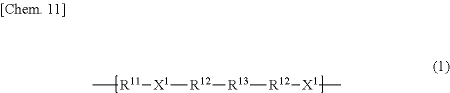

In the formula (1),
R¹¹ represents a divalent substituted or unsubstituted nitrogen-containing heteroaromatic ring,
R¹²'s independently represent a divalent substituted or unsubstituted aromatic hydrocarbon group,
R¹³ represents a hydrocarbon group having 1 to 20 carbon atoms to which at least one group represented by a formula (a1) below is bonded in addition to two R¹²'s,
X¹'s independently represent —O—, —S—, or —N(R¹⁴)—, and
R¹⁴ is a hydrogen atom, a monovalent hydrocarbon group having 1 to 20 carbon atoms, a monovalent halogenated hydrocarbon group having 1 to 20 carbon atoms, or a group in which the hydrocarbon group or the halogenated hydrocarbon group is partially substituted with at least one selected from an oxygen atom and a sulfur atom.

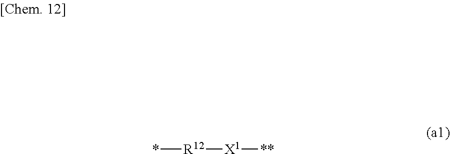

In the formula (a1),
* represents a linkage to the R¹³,
** represents a bond to another structural unit in the polymer (A), and
R¹² and X¹ have the same meaning as R¹² and X¹ in the formula (1), respectively.
R¹¹ in the formula (1) represents a divalent substituted or unsubstituted nitrogen-containing heteroaromatic ring. Specific examples of the nitrogen-containing heteroaromatic ring include a pyrrole ring, a pyridine ring, a pyrimidine ring, a pyrazine ring, a pyridazine ring, a triazine ring, a quinoline ring, an isoquinoline ring, a quinoxaline ring, a phthalazine ring, a quinazoline ring, a naphthyridine ring, a carbazole ring, an acridine ring, and a phenazine ring.

The nitrogen-containing heteroaromatic ring is preferably a pyrimidine ring, for example, from the viewpoint that the polymer (A) can be synthesized with good polymerization reactivity, and the polymer (A) excellent in solubility in various organic solvents can be easily obtained.

The positions of two bonds bonded to the nitrogen-containing heteroaromatic ring (bonds bonded to, for example, X¹) are not particularly limited, but the meta position is preferable from the viewpoint that the polymer (A) can be synthesized with good polymerization reactivity.

Examples of the substituent in the nitrogen-containing heteroaromatic ring include a halogen atom, a monovalent hydrocarbon group having 1 to 20 carbon atoms, a monovalent halogenated hydrocarbon group having 1 to 20 carbon atoms, a group in which the hydrocarbon group or the halogenated hydrocarbon group is partially substituted with at least one selected from an oxygen atom and a sulfur atom, a nitro group, a cyano group, an amino group, and a salt of an amino group.

Examples of the halogen atom include a fluorine atom, a chlorine atom, a bromine atom, and an iodine atom.

Examples of the monovalent hydrocarbon group having 1 to 20 carbon atoms include a monovalent chain hydrocarbon group, a monovalent alicyclic hydrocarbon group, and a monovalent aromatic hydrocarbon group.

Examples of the chain hydrocarbon group include alkyl groups such as a methyl group, an ethyl group, a n-propyl group, an isopropyl group, a n-butyl group, an isobutyl group, a sec-butyl group, a tert-butyl group, and a n-pentyl group; alkenyl groups such as an ethenyl group, a propenyl group, a butenyl group, and a pentenyl group; and alkynyl groups such as an ethynyl group, a propynyl group, a butynyl group, and a pentynyl group.

Examples of the monovalent alicyclic hydrocarbon group include monocyclic cycloalkyl groups such as a cyclopropyl group, a cyclobutyl group, a cyclopentyl group, and a cyclohexyl group; polycyclic cycloalkyl groups such as a norbornyl group and an adamantyl group; monocyclic cycloalkenyl groups such as a cyclopropenyl group, a cyclobutenyl group, a cyclopentenyl group, and a cyclohexenyl group; and polycyclic cycloalkenyl groups such as a norbornenyl group.

Examples of the monovalent aromatic hydrocarbon group include aryl groups such as a phenyl group, a tolyl group, a xylyl group, a naphthyl group, and an anthryl group; and aralkyl groups such as a benzyl group, a phenethyl group, a phenylpropyl group, and a naphthylmethyl group.

Examples of the monovalent halogenated hydrocarbon group having 1 to 20 carbon atoms include groups in which some or all of the hydrogen atoms of the monovalent hydrocarbon group having 1 to 20 carbon atoms are substituted with a halogen atom such as a fluorine atom, a chlorine atom, a bromine atom, or an iodine atom.

Specific examples of the group in which the monovalent hydrocarbon group having 1 to 20 carbon atoms or the monovalent halogenated hydrocarbon group having 1 to 20 carbon atoms is partially substituted with at least one selected from an oxygen atom and a sulfur atom include a group in which the hydrocarbon group or the halogenated hydrocarbon group is partially substituted with —O—, —S—, an ester group, or a sulfonyl group.

The amino group is not particularly limited, and may be a primary amino group (—NH₂), a secondary amino group (—NHR), or a tertiary amino group (—NR₂).

The substituent (R) in the secondary amino group and the tertiary amino group is not particularly limited, and examples thereof include the monovalent hydrocarbon group having 1 to 20 carbon atoms described above.

The anion constituting the anion site in the salt of the amino group is not particularly limited, and examples thereof include known anions such as Cl⁻.

As the substituent in the nitrogen-containing heteroaromatic ring, from the viewpoint that the polymer (A) can be synthesized with good polymerization reactivity and the solubility of a monomer serving as a raw material of the polymer (A) is improved, a halogen atom, a monovalent hydrocarbon group having 1 to 6 carbon atoms, a monovalent halogenated hydrocarbon group having 1 to 6 carbon atoms, a nitro group, a cyano group, an amino group, or a salt of an amino group is preferable, and a fluorine atom, a chlorine atom, a methyl group, a nitro group, a cyano group, a tert-butyl group, a phenyl group, or a primary amino group is more preferable.

Examples of a monomer serving as a raw material of a moiety containing the R¹¹ include pyrimidine compounds such as 4,6-dichloropyrimidine, 4,6-dibromopyrimidine, 2,4-dichloropyrimidine, 2,5-dichloropyrimidine, 2,5-dibromopyrimidine, 5-bromo-2-chloropyrimidine, 5-bromo-2-fluoropyrimidine, 5-bromo-2-iodopyrimidine, 2-chloro-5-fluoropyrimidine, 2-chloro-5-iodopyrimidine, 2-phenyl-4,6-dichloropyrimidine, 2-methylthio-4,6-dichloropyrimidine, 2-methylsulfonyl-4,6-dichloropyrimidine, 5-methyl-4,6-dichloropyrimidine, 2-amino-4,6-dichloropyrimidine, 5-amino-4,6-dichloropyrimidine, 2,5-diamino-4,6-dichloropyrimidine, 4-amino-2,6-dichloropyrimidine, 5-methoxy-4,6-dichloropyrimidine, 5-methoxy-2,4-dichloropyrimidine, 2-methyl-4,6-dichloropyrimidine, 6-methyl-2,4-dichloropyrimidine, 5-methyl-2,4-dichloropyrimidine, 5-nitro-2,4-dichloropyrimidine, 4-amino-2-chloro-5-fluoropyrimidine, 2-methyl-5-amino-4,6-dichloropyrimidine, and 5-bromo-4-chloro-2-methylthiopyrimidine; pyridazine compounds such as 3,6-dichloropyridazine, 3,5-dichloropyridazine, and 4-methyl-3,6-dichloropyridazine; and pyrazine compounds such as 2,3-dichloropyrazine, 2,6-dichloropyrazine, 2,5-dibromopyrazine, 2,6-dibromopyrazine, 2-amino-3,5-dibromopyrazine, and 5,6-dicyano-2,3-dichloropyrazine. One kind of these monomers may be used singly, or two or more kinds thereof may be used.

R¹²'s in the formulae (1) and (a1) independently represent a divalent substituted or unsubstituted aromatic hydrocarbon group.

Examples of the divalent unsubstituted aromatic hydrocarbon group include aromatic hydrocarbon groups having 6 to 20 carbon atoms such as a phenylene group, a naphthylene group, and an anthrylene group.

The substituent in the divalent substituted aromatic hydrocarbon group is not particularly limited, and examples thereof include an allyl group, a halogen atom, a monovalent hydrocarbon group having 1 to 20 carbon atoms, a monovalent halogenated hydrocarbon group having 1 to 20 carbon atoms, an alkoxy group having 1 to 20 carbon atoms, an alkylthio group having 1 to 20 carbon atoms, a nitro group, a cyano group, a carboxy group, a sulfonic acid group, a phosphonic acid group, a phosphoric acid group, a hydroxy group, primary to tertiary amino groups, a salt of a carboxy group, a salt of sulfonic acid group, a salt of phosphonic acid group, a salt of a phosphoric acid group, a salt of a hydroxy group, and salts of primary to tertiary amino groups.

From the viewpoint of improving the glass transition temperature (Tg) of the polymer (A), —R¹²-'s in the formulae (1) and (a1) are preferably independently a structure represented by the following formula (5).

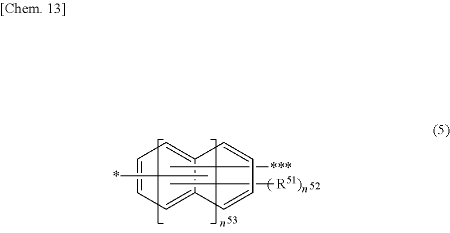

In the formula (5),
* represents a linkage to the R¹³,
*** represents a bond to the X¹, and

R⁵¹ represents an alkyl group having 1 to 10 carbon atoms, an alkoxy group having 1 to 10 carbon atoms, or a cycloalkyl group having 3 to 10 carbon atoms, n⁵² represents an integer of 0 to 4, and n⁵³ represents an integer of 0 to 2.

In addition, the structure represented by the formula (5) is preferably the following formula (5-1) or the following formula (5-2) from the viewpoint of maintaining a low permittivity and a low dissipation factor and improving heat resistance (Tg of the polymer (A)).

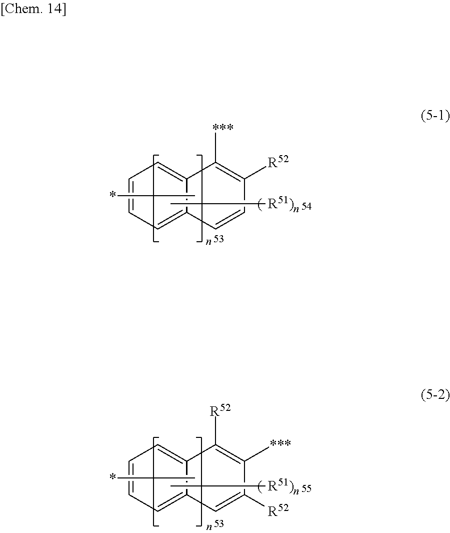

In the formulae (5-1) and (5-2),
* represents a linkage to the R¹³,
*** represents a bond to the X¹,
R⁵¹ and n⁵³ have the same meaning as R⁵¹ and n⁵³ in the formula (5),
n⁵⁴ represents an integer of 0 to 3, and n⁵⁵ represents an integer of 0 to 2; and
R⁵² represents an alkyl group having 1 to 10 carbon atoms, an alkoxy group having 1 to 10 carbon atoms, or a cycloalkyl group having 3 to 10 carbon atoms.

Examples of the alkyl group having 1 to 10 carbon atoms in R⁵¹ and R⁵² include a methyl group, an ethyl group, a n-propyl group, an isopropyl group, a n-butyl group, an isobutyl group, a sec-butyl group, a tert-butyl group, and a n-pentyl group.

Examples of the alkoxy group having 1 to 10 carbon atoms in R⁵¹ and R⁵² include a methoxy group, an ethoxy group, a n-propoxy group, an isopropoxy group, a butoxy group, a pentyloxy group, a hexyloxy group, and an octyloxy group.

Examples of the cycloalkyl group having 3 to 10 carbon atoms in R⁵¹ and R⁵² include a cyclopropyl group, a cyclobutyl group, a cyclopentyl group, and a cyclohexyl group.

The n⁵² represents an integer of 0 to 4, preferably an integer of 1 to 3. In addition, the n⁵³ represents an integer of 0 to 2, and is preferably 0 or 1. In addition, the n⁵⁴ represents an integer of 0 to 3, preferably an integer of 0 to 2, and the n⁵⁵ represents an integer of 0 to 2, preferably 0 or 1.

R¹³ in the formula (1) represents a hydrocarbon group having 1 to 20 carbon atoms to which at least one group represented by the formula (a1) is bonded in addition to the two R¹²'s. The structure of the hydrocarbon group is not particularly limited, and may contain an aromatic ring or an alicyclic ring.

When a moiety excluding the group represented by the formula (a1) in R¹³ is represented by Z, a partial structure represented by —R¹²—R¹³—R¹²— in the repeating unit (1) can be represented by the following formula (1′). That is, the repeating unit (1) has a branched structure.

The branched structure is preferably formed of a tertiary carbon or a quaternary carbon in the Z.

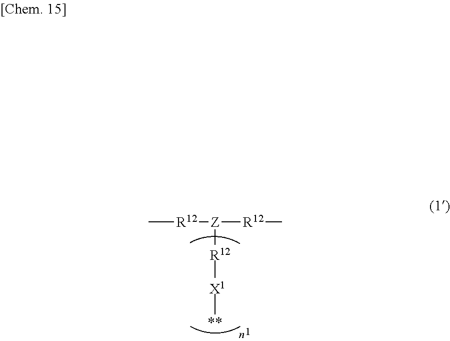

In the formula (1′), n represents an integer of 1 or more.

Examples of the monomer serving as a raw material of the partial structure represented by the —R¹²R¹³—R¹²— include a compound represented by the following formula (6).

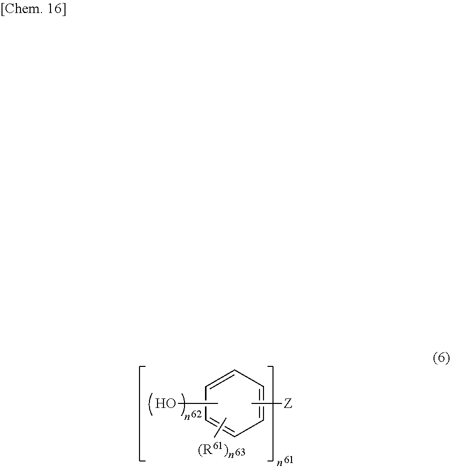

In the formula (6),
Z represents an n⁶¹-valent hydrocarbon group having 1 to 20 carbon atoms,
R⁶¹'s independently represent an alkyl group having 1 to 10 carbon atoms, an alkoxy group having 1 to 10 carbon atoms, or a cycloalkyl group having 3 to 10 carbon atoms,
n⁶¹ represents an integer of 2 or more and 4 or less,
n⁶²'s independently represent an integer of 1 to 5, n⁶³ represents an integer of 0 to 4, and 1≤n⁶²+n⁶³≤5.

The compound represented by the formula (6) is preferably a compound represented by the following formula (6-1) or the following formula (6-2).

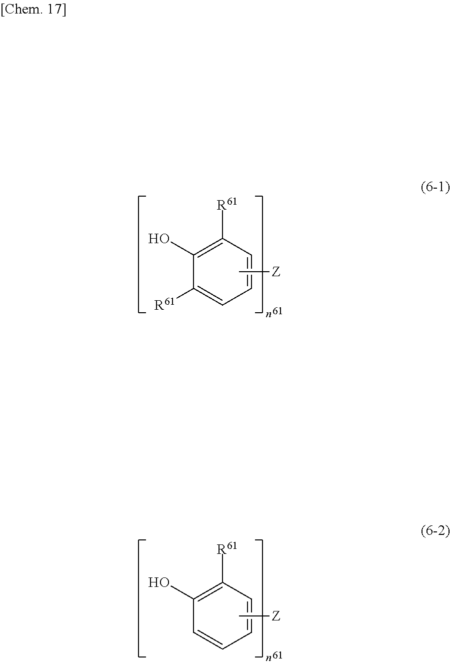

In the formulae (6-1) and (6-2), 2, R, and a: have the same meaning as Z, R⁶¹, and n⁶¹ in the formula (6).

Specific examples of the compound represented by the formula (6) include compounds shown below.

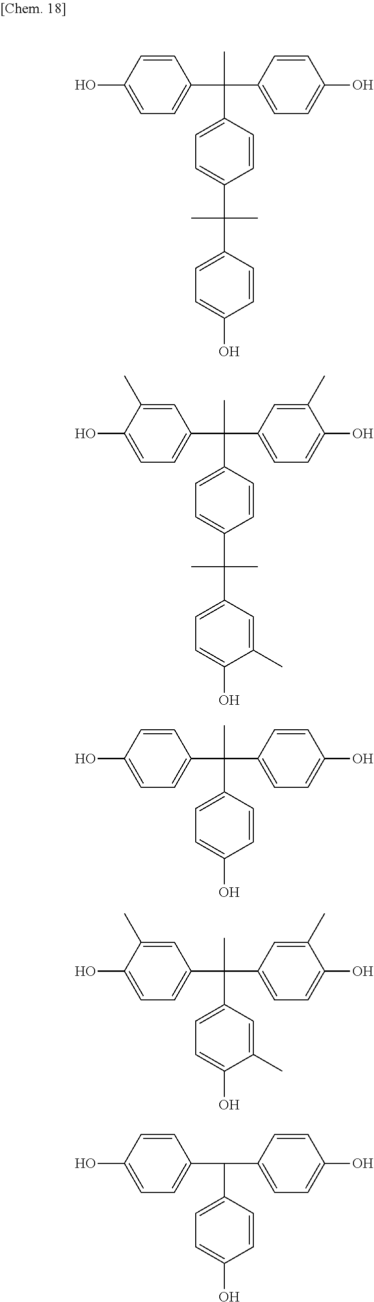

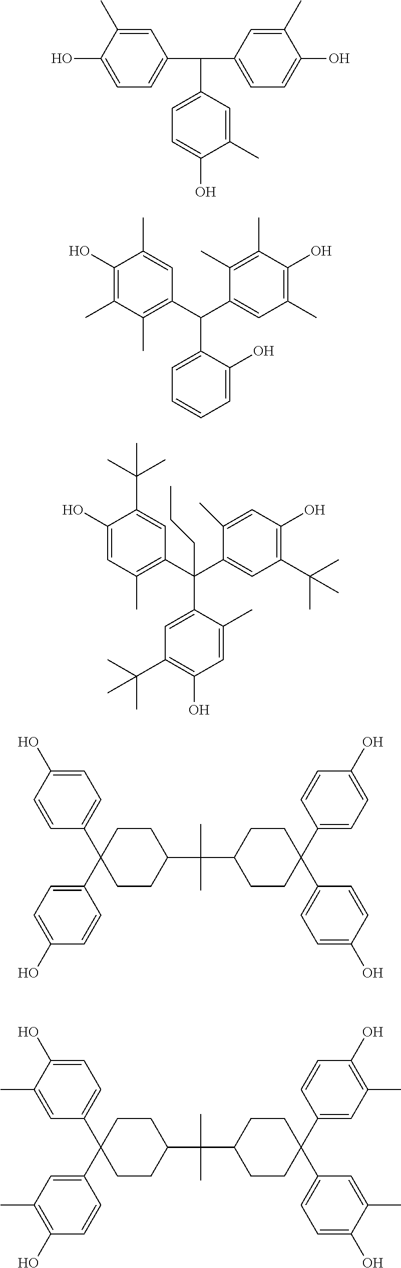

X's in the formulae (1) and fall independently represent —O—, —S—, or —N(R¹⁴)—. X¹ is preferably —O— from the viewpoint of flexibility, solubility, and heat resistance. X¹ is preferably —N(R¹⁴)— from the viewpoint of, for example, adhesion.

R¹⁴ is a hydrogen atom, a monovalent hydrocarbon group having 1 to 20 carbon atoms, a monovalent halogenated hydrocarbon group having 1 to 20 carbon atoms, or a group in which the hydrocarbon group or the halogenated hydrocarbon group is partially substituted with at least one selected from an oxygen atom and a sulfur atom.

Examples of the monovalent hydrocarbon group having 1 to 20 carbon atoms and the monovalent halogenated hydrocarbon group having 1 to 20 carbon atoms in R¹⁴ include the monovalent hydrocarbon group having 1 to 20 carbon atoms and the monovalent halogenated hydrocarbon group having 1 to 20 carbon atoms exemplified for the substituent in the nitrogen-containing heteroaromatic ring of R¹¹. Specific examples of the group in which the monovalent hydrocarbon group having 1 to 20 carbon atoms or the monovalent halogenated hydrocarbon group having 1 to 20 carbon atoms is partially substituted with at least one selected from an oxygen atom and a sulfur atom in R¹⁴ include a group in which the hydrocarbon group or the halogenated hydrocarbon group is partially or entirely substituted with an ester group or a sulfonyl group.

From the viewpoint that the polymer (A) can be synthesized with good polymerization reactivity, R¹⁴ is preferably a hydrogen atom or a monovalent hydrocarbon group having 1 to 10 carbon atoms.

In the formula (1), when two X's are —N(R¹⁴)—, two R¹⁴'s may be the same as or different from each other.

** in the formula (a1) represents a bond to another structural unit in the polymer (A). Here, the another structural unit may be another repeating unit (1), or may be a repeating structural unit represented by a formula (2) described later, another structural unit, or a terminal group Y. When ** in a certain repeating unit (1) represents a bond to another repeating unit (1), the ** is bonded to R¹¹ in the another repeating unit (1) and is not bonded to X¹.

When all structural units contained in the polymer (A) are taken as 100 mol %, the content ratio of the repeating unit (1) is preferably 5 mol % or more and 95 mol % or less, more preferably 10 mol % or more and 90 mol % or less, and still more preferably 20 mol % or more and 80 mol % or less.

The polymer (A) preferably further has a repeating structural unit represented by the following formula (2) (hereinafter also referred to as “repeating unit (2)”) in addition to the repeating unit (1).

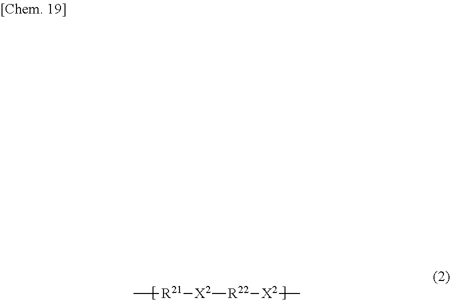

In the formula (2),
R²¹ represents a divalent substituted or unsubstituted nitrogen-containing heteroaromatic ring,
R²² represents a divalent group containing a substituted or unsubstituted aromatic hydrocarbon group in a main chain,
X² represents —O—, —S—, or —N(R²⁴)—, and
R²⁴ is a hydrogen atom, a monovalent hydrocarbon group having 1 to 20 carbon atoms, a monovalent halogenated hydrocarbon group having 1 to 20 carbon atoms, or a group in which the hydrocarbon group or the halogenated hydrocarbon group is partially substituted with at least one selected from an oxygen atom and a sulfur atom.

R²¹ in the formula (2) represents a divalent substituted or unsubstituted nitrogen-containing heteroaromatic ring.

Specific examples and preferable aspects of R²¹ are similar to the contents exemplified for R¹¹ in the formula (1). Examples of a monomer serving as a raw material of a moiety containing the R²¹ include monomers similar to the monomers exemplified for R¹¹ in the formula (1).

R²² in the formula (2) represents a divalent group containing a substituted or unsubstituted aromatic hydrocarbon group in a main chain. The divalent group preferably contains a group represented by the following formula (2-1).

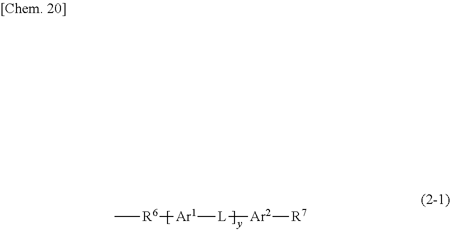

In the formula (2-1),
Ar¹ and Ar² are each independently an unsubstituted or substituted aromatic hydrocarbon group.
L is a single bond, —O—, —S—, —N(R⁸)—, —C(O)—, —C(O)—O—, —C(O)—NH—, —S(O)—, —S(O)₂—, —P(O)—, or a divalent organic group, and R⁸ is a hydrogen atom, a monovalent hydrocarbon group having 1 to 20 carbon atoms, or a monovalent halogenated hydrocarbon group having 1 to 20 carbon atoms.
y is an integer of 0 to 5. When y is 2 or more, a plurality of Ar¹'s and L's may be the same as or different from each other.
R⁶ and R⁷ are each independently a single bond, a methylene group, or an alkylene group having 2 to 4 carbon atoms.

The aromatic hydrocarbon groups represented by Ar¹ and Ar² are each independently preferably an aromatic hydrocarbon group having 6 to 30 carbon atoms, more preferably a phenyl group, a naphthyl group, or an anthryl group, and particularly preferably a phenyl group or a naphthyl group.

Each of the aromatic hydrocarbon groups represented by Ar¹ and Ar² may have 1 to 8 substituents. The number of substituents that each of the aromatic hydrocarbon groups represented by Ar¹ and Ar² has is preferably 0 to 8, more preferably 0 to 4, and still more preferably 0 to 2 from the viewpoint that, for example, the polymer (A) can be synthesized with good polymerization reactivity.

The substituent in Ar¹ and Ar² is not particularly limited, and examples thereof include an allyl group, a halogen atom, a monovalent hydrocarbon group having 1 to 20 carbon atoms, a monovalent halogenated hydrocarbon group having 1 to 20 carbon atoms, an alkoxy group having 1 to 20 carbon atoms, an alkylthio group having 1 to 20 carbon atoms, a nitro group, a cyano group, a carboxy group, a sulfonic acid group, a phosphonic acid group, a phosphoric acid group, a hydroxy group, primary to tertiary amino groups, a salt of a carboxy group, a salt of sulfonic acid group, a salt of phosphonic acid group, a salt of a phosphoric acid group, a salt of a hydroxy group, and salts of primary to tertiary amino groups.

Examples of the halogen atom include a fluorine atom, a chlorine atom, a bromine atom, and an iodine atom.

Examples of the monovalent hydrocarbon group having 1 to 20 carbon atoms include a monovalent chain hydrocarbon group, a monovalent alicyclic hydrocarbon group, and a monovalent aromatic hydrocarbon group, and a monovalent chain hydrocarbon group is preferable in terms of polymerizability and low dielectric properties of the polymer.

Examples of the chain hydrocarbon group include alkyl groups such as a methyl group, an ethyl group, a n-propyl group, an isopropyl group, a n-butyl group, an isobutyl group, a sec-butyl group, a tert-butyl group, and a n-pentyl group; alkenyl groups such as an ethenyl group, a propenyl group, a butenyl group, and a pentenyl group; and alkynyl groups such as an ethynyl group, a propynyl group, a butynyl group, and a pentynyl group.

The divalent organic group in L is preferably a divalent organic group having 1 to 20 carbon atoms, and examples thereof include a substituted or unsubstituted methylene group, an alkylene group having 2 to 20 carbon atoms, a halogenated alkylene group having 2 to 20 carbon atoms, a divalent cardo structure, and a group represented by the following formula (L1).

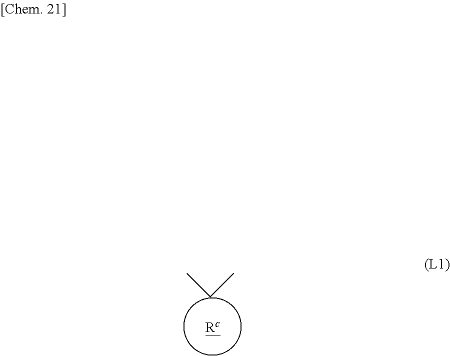

In the formula (L1), R^{c} is an unsubstituted or substituted 5- to 30-membered divalent alicyclic hydrocarbon group.

Examples of the substituted methylene group in L include a methylene group substituted with an alkyl group having 1 to 5 carbon atoms, and examples thereof include 1-methylmethylene, 1-ethylmethylene, 1,1-dimethylmethylene, 1-ethyl1-methylmethylene, and 1,1-bistrifluoromethylmethylene.

Examples of the alkylene group having 2 to 20 carbon atoms in L include an ethylene group, a n-propylene group, an isopropylene group, a n-butylene group, a sec-butylene group, a neopentylene group, a 4-methyl-pentane-2,2-diyl group, a nonane-1,9-diyl group, and a decane-1,1-diyl group.

Examples of the halogenated methylene group in L include groups in which some or all of the hydrogen atoms of the methylene group are substituted with a halogen atom such as a fluorine atom, a chlorine atom, a bromine atom, or an iodine atom.

Examples of the halogenated alkylene group having 2 to 20 carbon atoms in L include groups in which some or all of the hydrogen atoms of the alkylene group having 2 to 20 carbon atoms are substituted with a halogen atom such as a fluorine atom, a chlorine atom, a bromine atom, or an iodine atom.

Examples of the divalent cardo structure in L include a divalent group derived from fluorene represented by the following formula (L2) (that is, a group excluding two hydrogen atoms in a compound having a fluorene skeleton).

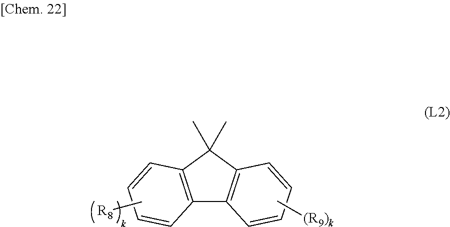

In the formula (L2), R₈ and R₉ are each independently a hydrogen atom, a fluorine atom, or a monovalent chain hydrocarbon group having 1 to 20 carbon atoms, and k's are independently an integer of 0 to 4.

Examples of the divalent cardo structure include a structure derived from a compound represented by the following formula.

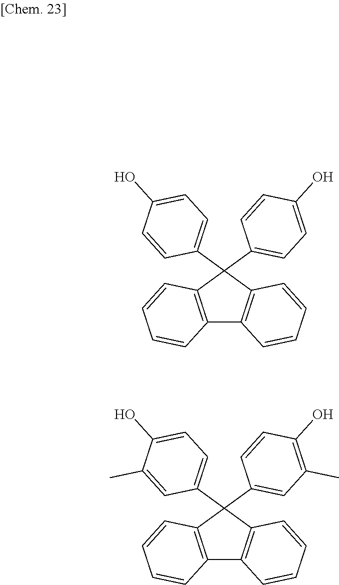

Examples of the unsubstituted or substituted 5- to 30-membered divalent alicyclic hydrocarbon group represented by R^{c} include an unsubstituted or substituted 5- to 15-membered monocyclic alicyclic hydrocarbon group, an unsubstituted or substituted 5- to 15-membered monocyclic fluorinated alicyclic hydrocarbon group, an unsubstituted or substituted 7- to 30-membered polycyclic alicyclic hydrocarbon group, and an unsubstituted or substituted 7- to 30-membered polycyclic fluorinated alicyclic hydrocarbon group.

Examples of the unsubstituted or substituted 5- to 15-membered monocyclic alicyclic hydrocarbon group include a cyclopentane-1,1-diyl group, a cyclohexane-1,1-diyl group, a 3, 3,5-trimethylcyclohexane-1,1-diyl group, a cyclopentene-3,3-diyl group, a cyclohexene-3,3-diyl group, a cyclooctane-1,1-diyl group, a cyclodecane-1,1-diyl group, a cyclododecane-1,1-diyl group, and a group in which some or all of the hydrogen atoms of such a group are substituted with a monovalent chain hydrocarbon group having 1 to 20 carbon atoms.

Examples of the unsubstituted or substituted 5- to 15-membered monocyclic fluorinated alicyclic hydrocarbon group include a group in which some or all of the hydrogen atoms of a group exemplified as the 5- to 15-membered monocyclic alicyclic hydrocarbon group are substituted with a fluorine atom.

Examples of the unsubstituted or substituted 7- to 30-membered polycyclic alicyclic hydrocarbon group include groups excluding two hydrogen atoms bonded to one carbon atom of a polycyclic alicyclic hydrocarbon such as norbornane, norbornene, adamantane, tricyclo[5.2.1.0^{2,6}]decane, tricyclo[5.2.1.0^{2,6}]heptane, pinane, camphane, decalin, nortricyclane, perhydroanthracene, perhydroazulene, cyclopentanohydrophenanthrene, and bicyclo[2.2.2]-2-octene, and a group in which some or all of the hydrogen atoms of such a group are substituted with a monovalent chain hydrocarbon group having 1 to 20 carbon atoms.

Examples of the unsubstituted or substituted 7- to 30-membered polycyclic fluorinated alicyclic hydrocarbon group include a group in which some or all of the hydrogen atoms of a group exemplified as the 7- to 30-membered polycyclic alicyclic hydrocarbon group are substituted with a fluorine atom.

R⁸ in —N(R⁸)— is a hydrogen atom, a monovalent hydrocarbon group having 1 to 20 carbon atoms, or a monovalent halogenated hydrocarbon group having 1 to 20 carbon atoms, and examples of each of the monovalent hydrocarbon group having 1 to 20 carbon atoms and the monovalent halogenated hydrocarbon group having 1 to 20 carbon atoms include the monovalent hydrocarbon group having 1 to 20 carbon atoms and the monovalent halogenated hydrocarbon group having 1 to 20 carbon atoms exemplified for Ar¹.

From the viewpoint of the structure stability of the polymer (A), L is preferably a single bond, —O—, —S—, —C(O)—, —S(O)—, —S(O)₂—, —C(O)—NH—, —C(O)—O—, a methylene group, a methylene group substituted with an alkyl group having 1 to 5 carbon atoms, an alkylene group having 2 to 5 carbon atoms, a halogenated methylene group, a halogenated alkylene group having 2 to 10, or a divalent cardo structure.

From a similar viewpoint, y is preferably 0 to 4, more preferably 0 to 3, and particularly preferably 0 to 1.

Examples of the alkylene group having 2 to 4 carbon atoms in R⁶ and R⁷ include an ethylene group, a n-propylene group, an isopropylene group, a n-butylene group, and a sec-butylene group.

From the viewpoint that the polymer (A) can be synthesized with good polymerization reactivity, Re and R⁷ are preferably each independently a single bond, a methylene group, or an ethylene group.

Examples of a monomer serving as a raw material of a moiety containing the R²² include dihydroxyphenyl compounds such as hydroquinone, resorcinol, catechol, and phenylhydroquinone; bisphenol compounds such as 9,9-bis(4-hydroxyphenyl) fluorene, 9,9-bis(4-hydroxy-3-methylphenyl) fluorene, 9,9-bis(4-hydroxy-3-phenylphenyl) fluorene, 1,1-bis(4-hydroxyphenyl)-1-phenylethane, bis(4-hydroxyphenyl)diphenylmethane, 2,2-bis(4-hydroxyphenyl)propane, 2,2-bis(4-hydroxy-3-allylphenyl)propane, 2,2-bis(4-hydroxy-3-methylphenyl)propane, 2,2-bis(4-hydroxy-3-phenylphenyl)propane, 4,4′-(1,3-dimethylbutylidene)bisphenol, 1,1-bis(4-hydroxyphenyl)-nonane, bis(4-hydroxyphenyl) sulfone, 1,1-bis(4-hydroxyphenyl)cyclohexane, 1,1-bis(4-hydroxyphenyl)-3, 3,5-trimethylcyclohexane, 1,1-bis(3-methyl-4-hydroxyphenyl)-3, 3,5-trimethylcyclohexane, 1,1-bis(3-cyclohexyl-4-hydroxyphenyl)-3, 3,5-trimethylcyclohexane, 1,4-bis[2-(4-hydroxyphenyl)-2-propyl]benzene, 1,3-bis[2-(4-hydroxyphenyl)-2-propyl]benzene, 4,4′-cyclododecylidene bisphenol, 4,4′-decylidene bisphenol, and 4,4′-dihydroxy-2,2′,3,3′,5,5′-hexamethylbiphenyl; and diol compounds such as Priplast 1901, 1838, 3186, 3192, 3197, and 3199 (manufactured by Croda Japan KK). One kind of these monomers may be used singly, or two or more kinds thereof may be used.

X²'s in the formula (2) are independently —O—, —S—, or —N(R²⁴)—. Specific examples and preferable aspects of X² are similar to the contents exemplified for XI in the formula (1).

When ** in the repeating unit (1) represents a bond to the repeating unit (2), the ** is bonded to R²¹ in the repeating unit (2) and is not bonded to X².

When all structural units contained in the polymer (A) are taken as 100 mol %, the content ratio of the repeating unit (2) is preferably 5 mol % or more and 95 mol % or less, more preferably 10 mol % or more and 90 mol % or less, and still more preferably 20 mols or more and 80 mol % or less.

The polymer (A) preferably has a group Y represented by the following formula (y) (hereinafter also referred to as “terminal group Y”) at the terminal.

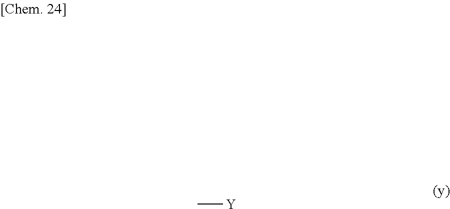

In the formula (y), Y represents a group containing an ethylenically unsaturated double bond and having 3 to 50 carbon atoms, a substituted or unsubstituted aromatic hydrocarbon group having 6 to 50 carbon atoms, a substituted or unsubstituted aliphatic hydrocarbon group having 6 to 50 carbon atoms, or an unsubstituted nitrogen-containing heteroaromatic ring.

When the terminal group Y is bonded to, for example, the repeating unit (1), the terminal group Y is bonded to X¹ but is not bonded to R¹¹. Similarly, when the terminal group Y is bonded to the repeating unit (2), the terminal group Y is bonded to X² but is not bonded to R²¹.

The terminal group Y is preferably an aromatic or aliphatic hydrocarbon group having small polarization or a nitrogen-containing heteroaromatic ring in order to improve dielectric properties, and when the terminal group Y further contains an ethylenically unsaturated double bond, the cross-linking density can be improved, and thus heat resistance and curability can be expected.

Examples of the group containing an ethylenically unsaturated double bond and having 3 to 50 carbon atoms include aromatic ring-containing groups such as a 3-isopropenylphenyl group, a 4-isopropenylphenyl group, a 2-allylphenyl group, a 2-methoxy-4-allylphenyl group, a 4-(1-propenyl)-2-methoxyphenyl group, a 4-vinylbenzyl group, a 3-vinylbenzyl group, and a 2-vinylbenzyl group, an allyl group, an acrylic group, a methacrylic group, and a methallyl group.

Examples of the aromatic hydrocarbon group having 6 to 50 carbon atoms include aryl groups such as a phenyl group, a biphenyl group, a tolyl group, a xylyl group, a naphthyl group, and an anthryl group; and aralkyl groups such as a benzyl group, a phenethyl group, a phenylpropyl group, and a naphthylmethyl group.

Examples of the aliphatic hydrocarbon group having 6 to 50 carbon atoms include monocyclic cycloalkyl groups such as a cyclopropyl group, a cyclobutyl group, a cyclopentyl group, and a cyclohexyl group; polycyclic cycloalkyl groups such as a norbornyl group and an adamantyl group; monocyclic cycloalkenyl groups such as a cyclopropenyl group, a cyclobutenyl group, a cyclopentenyl group, and a cyclohexenyl group; and polycyclic cycloalkenyl groups such as a norbornenyl group.

Examples of the unsubstituted nitrogen-containing heteroaromatic ring include rings similar to the rings exemplified for R¹¹.

The substituent in the unsubstituted or substituted aromatic hydrocarbon group having 6 to 50 carbon atoms, the unsubstituted or substituted aliphatic hydrocarbon group having 6 to 50 carbon atoms, and the unsubstituted nitrogen-containing heteroaromatic ring is a group other than a hydroxy group, and specific examples thereof include groups similar to the groups exemplified as the substituent in the Ar¹.

In addition to the monomer to give R¹¹ and R¹²—R¹³—R¹² in the formula (1), at least one monomer for forming the terminal group Y selected from the group consisting of a monovalent phenol, a monovalent amine, a monovalent thiol, a monovalent aromatic, a monovalent aliphatic halide, a monovalent acid halide, and a monovalent acid anhydride is used as a raw material and allowed to react, whereby a polymer (A) having a terminal sealed with the terminal group Y can be obtained.

In the case of synthesizing the polymer (A) in which the terminal group Y contains a double bond, for example, in order to avoid that the double bonds in a monomer for forming the terminal group Y react with each other to form a gel at the time of polymerization of a monomer serving as a raw material of a moiety containing R¹¹ and a monomer serving as a raw material of a moiety containing R¹² and R¹³, a monomer for forming the terminal group Y may be added and allowed to react after polymerization of the monomer serving as a raw material of a moiety containing R¹¹ and the monomer serving as a raw material of a moiety containing R¹² and R¹³.

Examples of the monomer for forming the terminal group Y include monovalent phenol compounds such as t-butylphenol, nonylphenol, 4-isopropenylphenol, 4-vinylphenol, 2-allylphenol, isoeugenol, tocotrienol, α-tocophenol, 4-hydroxyphenylmaleimide, and 2-phenylphenol; monovalent amines compound such as 4-hexylaniline and diallylamine; monovalent thiol compounds such as 1-octanethiol; monovalent aliphatic halides such as allyl chloride, 4-(chloromethyl) styrene, and 3-(chloromethyl) styrene; monovalent acid halides such as acrylic chloride, methacrylic chloride, crotonoyl chloride, and cinnamoyl chloride; and monovalent acid anhydrides such as acrylic anhydride, crotonic anhydride, and methacrylic anhydride. One kind of these monomers may be used singly, or two or more kinds thereof may be used.

The polymer (A) may have another structural unit as necessary in addition to the repeating units (1) and (2) and the terminal group Y. Therefore, for example, the repeating units (1) may be bonded to each other, or the repeating unit (1) may be bonded to the repeating unit (2), the another structural unit, or the terminal group Y.

When the polymer (A) has a plurality of repeating units (1), a plurality of R¹¹'s may be the same as or different from each other. The same applies to R¹² and R¹³, the repeating unit (2), and the another structural unit.

Examples of the monomer from which the another structural unit is derived include compounds from which a structural unit containing a carbonate bond, a thiocarbonate bond, or a selenocarbonate bond is derived, such as diphenyl carbonate, diphenyl thiocarbonate, diphenyl selenocarbonate, phosgene, thiophosgene, or selenophosgene; dihydroxy compounds such as benzenedimethanol and cyclohexanedimethanol; phosphine oxide compounds such as bis(fluorophenyl)phenylphosphine oxide, bis(fluorophenyl)naphthylphosphine oxide, and bis(fluorophenyl)anthrylphosphine oxide; and dihalides of dicarboxylic acids such as phthalic acid dichloride, isophthalic acid dichloride, and terephthalic acid dichloride. One kind of these monomers may be used singly, or two or more kinds thereof may be used.

### <Method for Synthesizing Polymer (A)>

A method for synthesizing the polymer (A) is not particularly limited, and a known method can be used. For example, the polymer (A) can be synthesized by heating a monomer serving as a raw material of a moiety containing the R¹¹, a monomer serving as a raw material of a moiety containing the R¹² and R¹³, if necessary, a monomer serving as a raw material of a moiety containing the R², a monomer serving as a raw material of a moiety containing the R²² and R¹³, a monomer for forming the terminal group Y, a monomer from which the another structural unit is derived in an organic solvent together with, for example, a polymerization inhibitor, an alkali metal, or an alkali metal compound. The monomer serving as a raw material of a moiety containing the R²¹, the monomer serving as a raw material of a moiety containing the R²² and R¹³, the monomer from which the another structural unit is derived, or the monomer for forming the terminal group Y may be allowed to react by heating and mixing after the monomer serving as a raw material of a moiety containing the R¹¹ and the monomer serving as a raw material of a moiety containing the R¹² are polymerized.

### Alkali Metal and Alkali Metal Compound

When a compound having a hydroxy group such as a phenol compound is used as a raw material in the process of synthesizing the polymer (A), the alkali metal and the alkali metal compound react with the compound having a hydroxy group to form an alkali metal salt.

Examples of such an alkali metal and an alkali metal compound include
alkali metals such as lithium, sodium, and potassium;
alkali metal hydrides such as lithium hydride, sodium hydride, and potassium hydride;
alkali metal hydroxides such as lithium hydroxide, sodium hydroxide, and potassium hydroxide;
alkali metal carbonates such as lithium carbonate, sodium carbonate, and potassium carbonate; and
alkali metal hydrogen carbonates such as lithium hydrogen carbonate, sodium hydrogen carbonate, and potassium hydrogen carbonate.

Among these, an alkali metal carbonate is preferable, and potassium carbonate is more preferable.

When a compound having a hydroxy group is used at the time of synthesis of the polymer (A), as amounts of the alkali metal and the alkali metal compound used, the lower limit of a ratio of the number of moles of alkali metal atoms to the number of moles of hydroxy groups in all compounds used in the synthesis of the polymer (A) is preferably 1, more preferably 1.1, and still more preferably 1.2, and the upper limit of the ratio is preferably 3, more preferably 2, and still more preferably 1.8.

### Organic Solvent

Examples of the organic solvent include ether-based solvents such as tetrahydrofuran (THE), dioxane, cyclopentyl methyl ether, anisole, phenitol, diphenyl ether, dialkoxybenzene, and trialkoxybenzene;
nitrogen-containing solvents such as N, N-dimethylacetamide (DMAc), N, N-dimethylformamide, N-methyl-2-pyrrolidone, and 1,3-dimethyl-2-imidazolidinone;
ester-based solvents such as γ-butyrolactone;
sulfur-containing solvents such as sulfolane, dimethyl sulfoxide, diethyl sulfoxide, dimethyl sulfone, diethyl sulfone, diisopropyl sulfone, and diphenyl sulfone;
ketone-based solvents such as benzophenone, 2-heptanone, cyclohexanone, and methyl ethyl ketone;
halogen-based solvents such as methylene chloride, chloroform, and chlorobenzene; and
aromatic hydrocarbon-based solvents such as benzene, toluene, and xylene.

Among these organic solvents, 2-heptanone, cyclohexanone, N-methyl-2-pyrrolidone, toluene, and xylene are preferable, and N-methyl-2-pyrrolidone, 2-heptanone, and cyclohexanone are more preferable.

The lower limit of the reaction temperature at the time of synthesis is preferably 50° C. and more preferably 80° C., and the upper limit thereof is preferably 300° C. and more preferably 200° C.

The lower limit of the reaction time at the time of synthesis is preferably 1 hour, more preferably 2 hours, and still more preferably 3 hours, and the upper limit thereof is preferably 100 hours, more preferably 50 hours, and still more preferably 24 hours.

For the purpose of suppressing gelation of a polymerization liquid, the lower limit of the reaction temperature when the monomer for forming the terminal group Y is added after polymerization is preferably 0° C. and more preferably 10° C., and the upper limit thereof is preferably 130° C. and more preferably 110° C.

The lower limit of the reaction time when the monomer for forming the terminal group Y is added and allowed to react after polymerization is preferably 1 hour, more preferably 2 hours, and still more preferably 3 hours, and the upper limit thereof is preferably 48 hours, more preferably 24 hours, and still more preferably 10 hours.

### Polymerization Inhibitor

The polymerization inhibitor can be used for ordinary purposes such as obtaining a target molecular weight by controlling a polymerization reaction. Examples of a quinone include p-benzoquinone, 2-t-butyl-p-benzoquinone, 2,5-diphenyl-p-benzoquinone, chloranyl, and trimethylquinone.

Examples of a hindered phenolic compound include 1,6-hexanediol-bis[3-(3,5-di-t-butyl-4-hydroxyphenyl)propionate], 2,4-bis-(n-octylthio)-6-(4-hydroxy-3,5-di-t-butylanilino)-3,5-triazine, pentaerythritol tetrakis[3-(3,5-t-butyl-4-hydroxyphenyl)propionate], 2,2-thio-diethylenebis[3-(3,5-di-t-butyl-4-hydroxyphenyl)propionate], octadecyl-3-(3,5-di-t-butyl-4 hydroxyphenyl)propionate, tris-(3,5-di-t-butyl-4-hydroxybenzyl)-isocyanurate, 2,6-di-tert-butyl-p-cresol (BHT), 1, 3,5-tris(3,5-di-tert-butyl-4-hydroxybenzyl)-1, 3,5-triazine-2, 4,6 (1H, 3H, 5H)-trione [AO-020, manufactured by ADEKA CORPORATION], and 1,3,5-tris(3,5-di-tert-butyl-4-hydroxyphenylmethyl)-2, 4,6-trimethylbenzene [AO-330, manufactured by ADEKA CORPORATION].

Examples of a hindered amine-based compound include 4-cyclohexylcarbonyloxy-2,2,6,6-tetramethylpiperidinoxyl, 4-benzoyloxy-2,2,6,6-tetramethylpiperidinoxyl, 2,2,6,6-tetramethyl-4-hydroxypiperidine-1-oxyl [ADEKA STAB LA-7RD, manufactured by ADEKA CORPORATION], and IRGASTAB UV 10 (4,4′-[1,10-dioxo-1,10-decanediyl)bis(oxy)]bis[2,2,6,6-tetramethyl]-1-piperidinyloxy).

Examples of an amine-based compound include phenothiazine, 3,7-dicumylphenothiazine, N,N′-diphenyl-1,4-phenylenediamine, and N,N′-di-2-naphthyl-1,4-phenylenediamine.

### [Physical Properties of Polymer (A)]

The lower limit of the weight average molecular weight (Mw) of the polymer (A) in terms of polystyrene is preferably 1,000, more preferably 2,000, and still more preferably 3,000, and the upper limit thereof is preferably 500,000, more preferably 100,000, still more preferably 50,000, and particularly preferably 30,000.

The polymer (A) having an Mw in the above range is excellent in, for example, adhesion, heat resistance, impregnation into a glass cloth, and moldability such as resin flow, in a well-balanced manner, and therefore is preferable. The Mw in the present invention is a value as measured by gel permeation chromatography (GPC) under the conditions described in the following examples.

The dissipation factor (tan δ) of the polymer (A) is preferably 0.0025 or less, more preferably 0.0020 or less, and still more preferably 0.0012 or less, and the lower limit thereof is not particularly limited, and is preferably 0.0005 or more, from the viewpoint that, for example, the transmission loss when a composition containing the polymer (A) is obtained can be reduced. Specifically, the dissipation factor can be measured by the method described in the following examples.

### <<First Composition>>

A first composition according to one embodiment of the present invention (hereinafter also referred to as “present composition (1)”) is not particularly limited as long as it contains the polymer (A), but preferably contains a curable compound (B) other than the polymer (A). The present composition (1) may further contain other components such as a curing aid.

### <Polymer (A)>

The polymer (A) used in the present composition (1) may be one or two or more kinds. The present composition (1) may be a mixture of two or more kinds of the polymers (A).

In the case of using two or more kinds of the polymers (A), for example, the polymer (A) having a different molecular weight in the range of the molecular weight of the polymer (A) can be mixed depending on, for example, desired physical properties.

The content ratio of the polymer (A) in the present composition (1) is preferably 10 mass % or more, more preferably 20 mass % or more, and still more preferably 50 mass % or more, and is preferably 99.95 mass % or less, more preferably 90 mass or less, and still more preferably 80 mass or less, for example, when the total solid content in the present composition (1) is regarded as 100 mass %. The content ratio of the polymer (A) within the above range is preferable from the viewpoint that, for example, adhesiveness, heat resistance, curability, and electrical properties of a cured product obtained from the present composition (1) can be further improved.

### <Curable Compound (B)>

The curable compound (B) (hereinafter also referred to as “compound (B)”) is a compound other than the polymer (A), is a compound that cures by heat or irradiation with light (for example: visible light, ultraviolet light, near infrared light, or far infrared light), and may require a curing aid described below. Examples of such a compound (B) include a vinyl compound, a maleimide compound, an allyl compound, an acrylic compound, a methacrylic compound, a thiol compound, an oxazine compound, a cyanate compound, an epoxy compound, an oxetane compound, a methylol compound, a benzocyclobutene compound, a propargyl compound, and a silane compound. Among these, from the viewpoint of, for example, compatibility and reactivity with the polymer (A), particularly, at least one of a vinyl compound, a maleimide compound, and an allyl compound is preferable.

One kind of the compound (B) may be used singly, or two or more kinds thereof may be used.

Examples of the vinyl compound include compounds represented by the following formulae (b-1-1) to (b-1-5).

Examples of the vinyl compound further include, as a styrene-based thermoplastic elastomer, compounds containing a vinyl group, such as a styrene butadiene styrene copolymer (SBS), a hydrogenated styrene butadiene styrene copolymer (SEBS), a styrene isoprene styrene copolymer (SIS), a hydrogenated styrene isoprene styrene copolymer, a styrene butadiene elastomer (SBR), tert-butylstyrene, and 2-vinyl-4,6-diamino-1, 3,5-triazine.

Examples of the vinyl compound further include TA100 (manufactured by MITSUBISHI GAS CHEMICAL COMPANY, INC.) and ULL-950S (manufactured by LONZA).

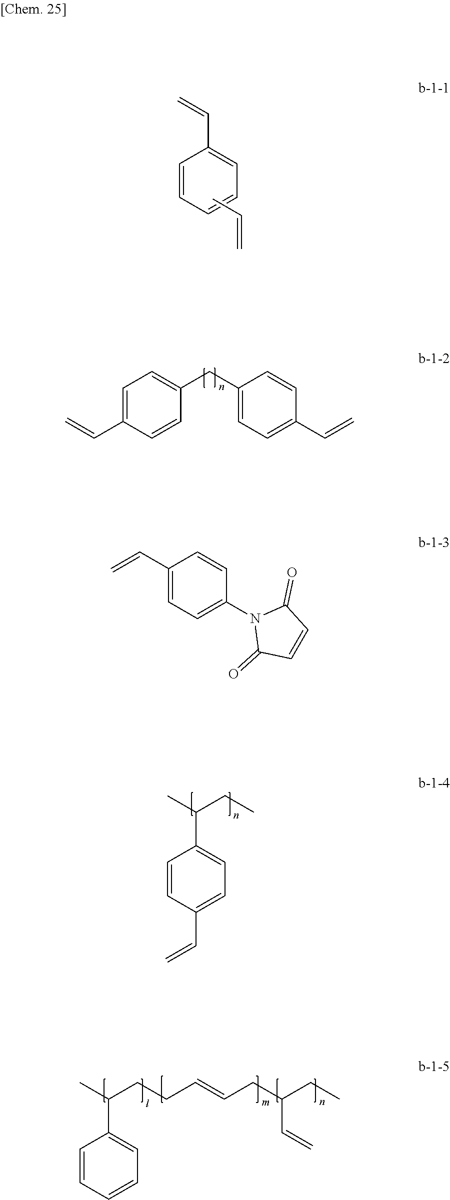

In the formulae (b-1-2) and (b-1-4), n is independently 1 to 5000. In the formula (b-1-5), 1, m, and n are each independently 1 to 5000.

Examples of the maleimide compound include compounds represented by the following formulae (b-2-1) to (b-2-8).

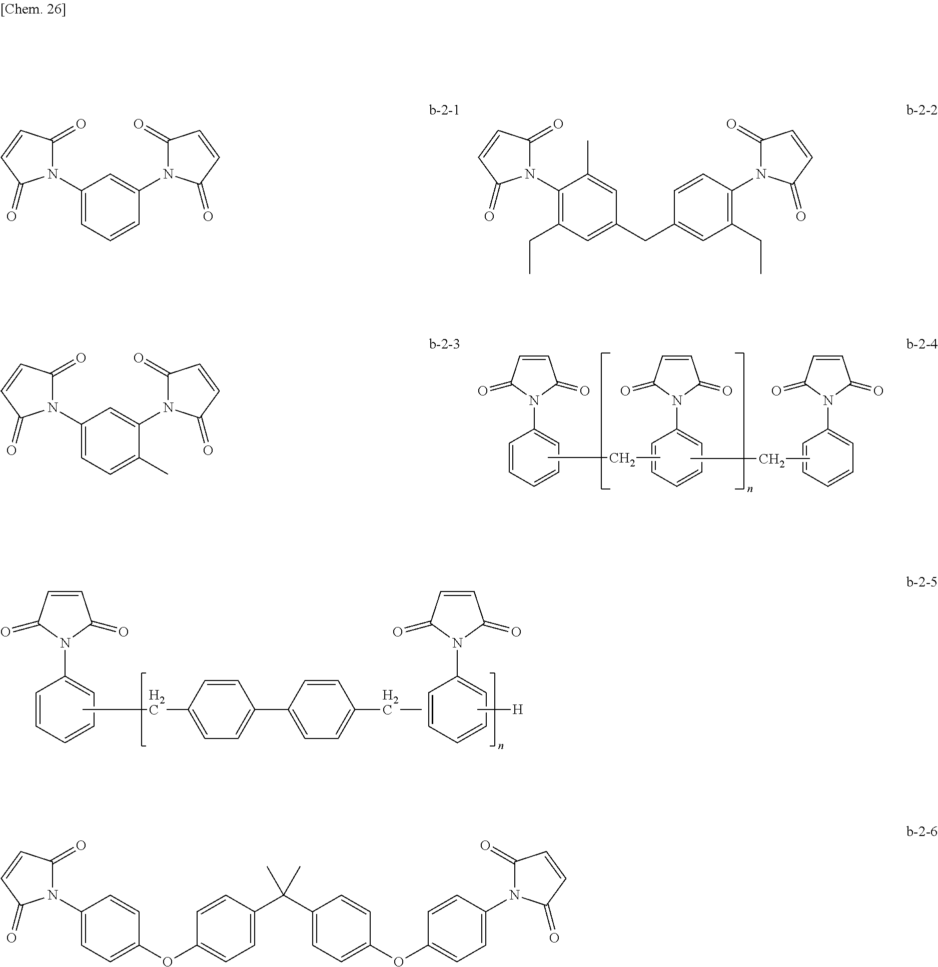

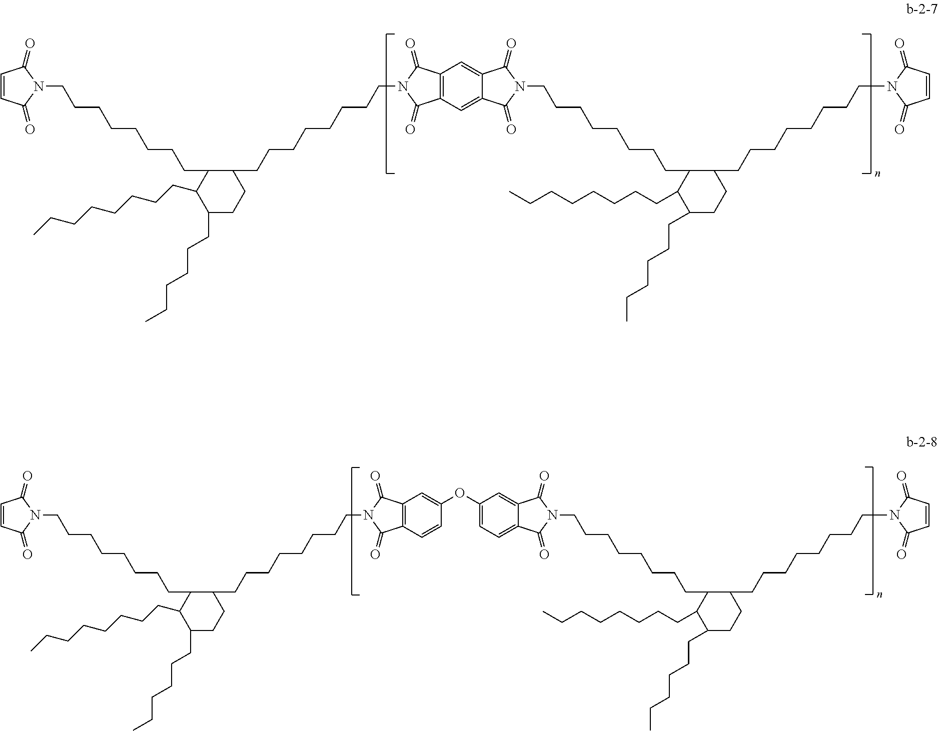

In the formulae (6-2-4), (6-2-5), (b-2-7), and (b-2-81, n is independently 1 to 50.

Examples of the allyl compound include compounds represented by the following formulae (b-3-1) to (b-3-6).

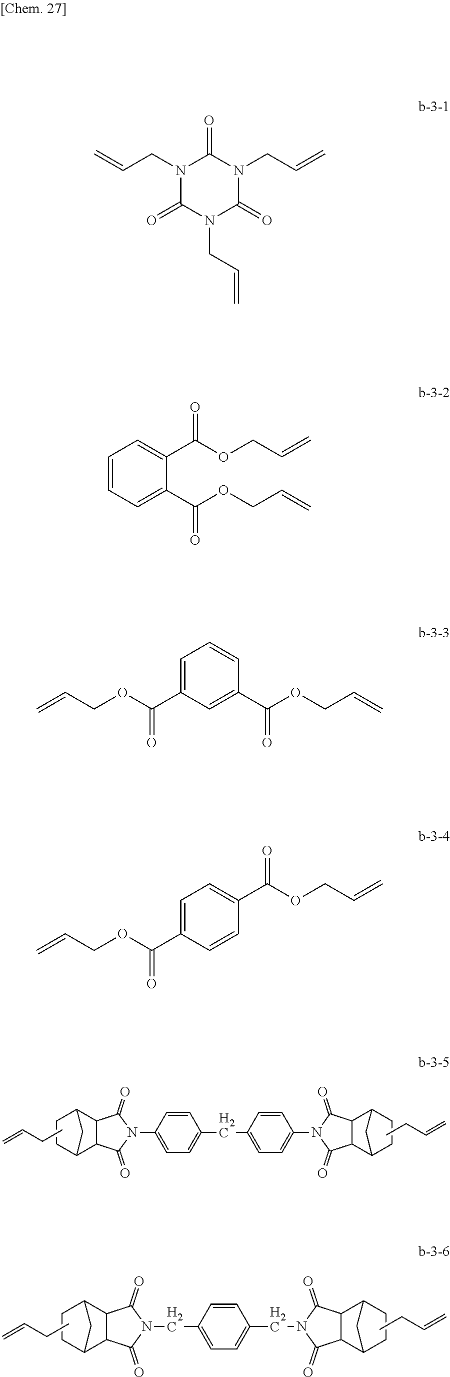

Examples of the acrylic compound include compounds represented by the following formulae (6-4-1) to (b-4-7).

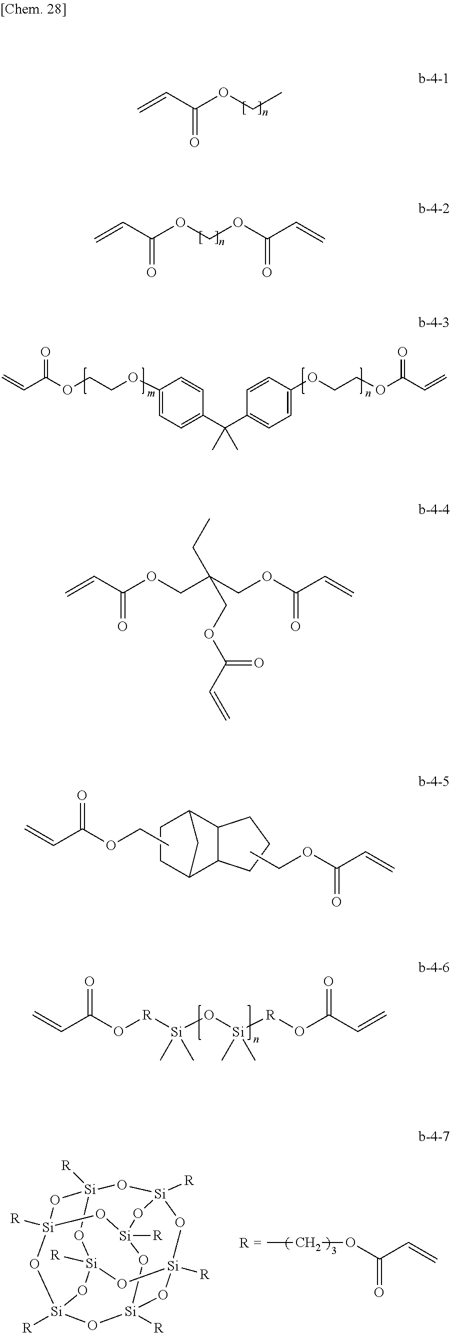

In the formulae (b-4-1), (b-4-2), (b-4-3), and (b-4-6), n is independently 1 to 50. In the formula (b-4-3), m is 1 to 50. In the formula (b-4-6), R is a divalent hydrocarbon group having 1 to 20 carbon atoms.

Examples of the methacrylic compound include bisphenol A-type epoxy methacrylate, phenol novolac-type epoxy methacrylate, trimethylolpropane methacrylate, dipentaerythritol hexamethacrylate, and SA-9000 (manufactured by SABIC).

Examples of the thiol compound include 1,4-bis(3-mercaptobutyryloxy)butane, 1, 3,5-tris(2-(3-sulfanylbutanoyloxy)ethyl)-1, 3,5-triazinane-2, 4,6-trione, 2-(dibutylamino)-1, 3,5-triazine-4,6-dithiol, and 6-diallylamino-1, 3,5-triazine-2,4-dithiol.

Examples of the silane compound include KF-99 (manufactured by Shin-Etsu Chemical Co., Ltd.) and KF-9901 (manufactured by Shin-Etsu Chemical Co., Ltd.).

Examples of the oxazine compound include compounds represented by the following formulae (b-5-1) to (b-5-5).

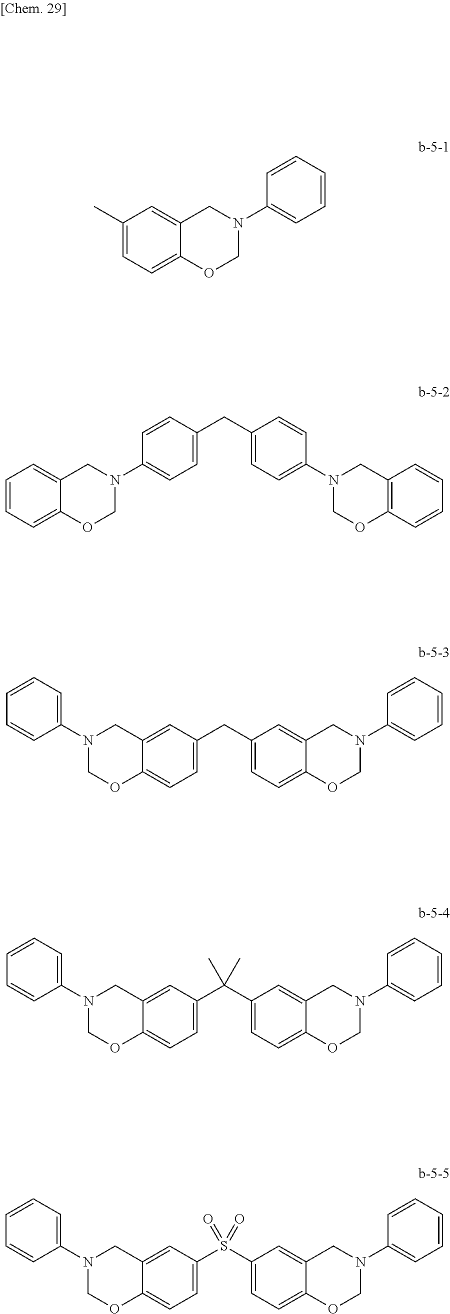 [SMILES: Cc1ccc2c(c1)CN(c1ccccc1)CO2 ; c1ccc2c(c1)CN(c1ccc(Cc3ccc(N4COc5ccccc5C4)cc3)cc1)CO2 ; c1ccc(N2COc3ccc(Cc4ccc5c(c4)CN(c4ccccc4)CO5)cc3C2)cc1 ; CC(C)(c1ccc2c(c1)CN(c1ccccc1)CO2)c1ccc2c(c1)CN(c1ccccc1)CO2 ; O=S(=O)(c1ccc2c(c1)CN(c1ccccc1)CO2)c1ccc2c(c1)CN(c1ccccc1)CO2]

Examples of the cyanate compound include compounds represented by the following formulae (b-6-1) to (b-6-7).

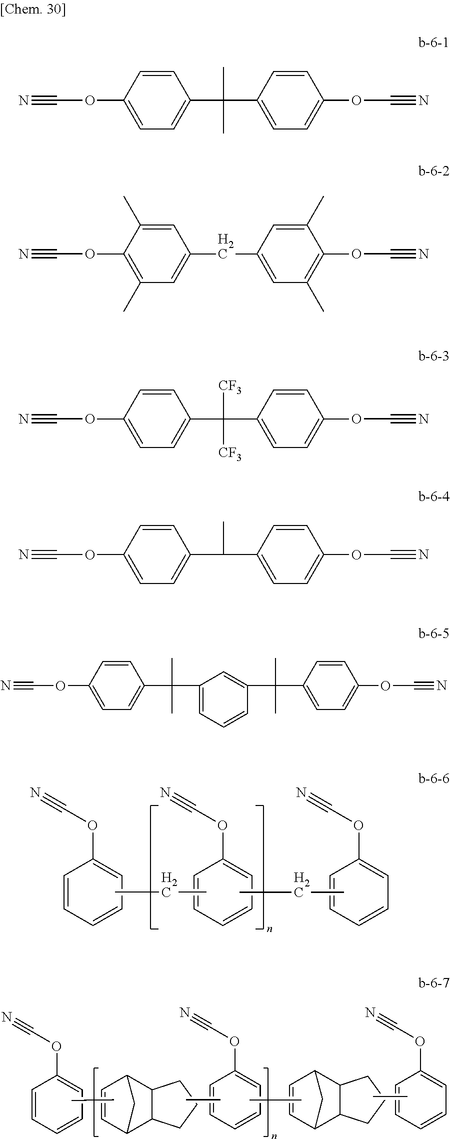

In the formulae (b-6-6) and (b-6-7), n is independently 0 to 30.

Examples of the epoxy compound include compounds represented by the following the formulae (b-7-1) to (b-7-5).

Examples of the epoxy compound further include polyglycidyl ether of a dicyclopentadiene-phenol polymer, a phenol novolac-type liquid epoxy compound, a cresol novolac-type epoxy compound, an epoxidized product of a styrene-butadiene block copolymer, 3′,4′-epoxycyclohexylmethyl-3,4-epoxycyclohexanecarboxylate, XER-81 (manufactured by JSR Corporation, epoxy group-containing NBR particles), and JP-100 (manufactured by Nippon Soda Co., Ltd.).

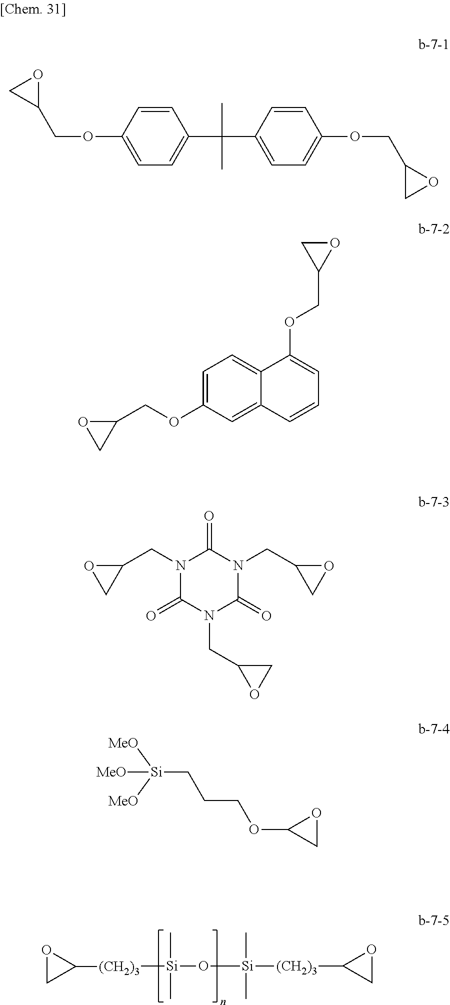

In the formula (b-7-5), n is 0 to 5000.

Examples of the oxetane compound include compounds represented by the following formulae (b-8-1) to (b-8-3).

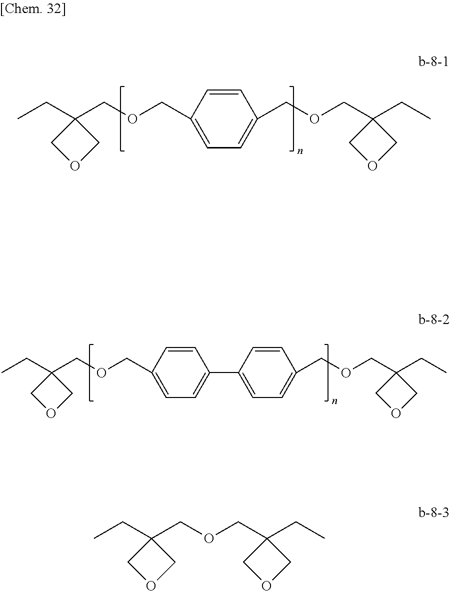

In the formulae (b-8-1) and (b-8-2), n is each independently 0 to 30.

Examples of the methylol compound include methylol compounds described in JP 2006-178059 A and JP 2012-226297 A. Specific examples thereof include melamine-based methylol compounds such as polymethylolated melamine, hexamethoxymethylmelamine, hexaethoxymethylmelamine, hexapropoxymethylmelamine, and hexabutoxymethylmelamine; glycoluril-based methylol compounds such as polymethylolated glycoluril, tetramethoxymethylglycoluril, and tetrabutoxymethylglycoluril; guanamine-based methylol compounds such as compounds in which guanamine is methylolated, such as 3,9-bis[2-(3,5-diamino-2, 4,6-triazaphenyl)ethyl]-2, 4, 8,10-tetraoxospiro[5.5]undecane and 3,9-bis[2-(3,5-diamino-2, 4,6-triazaphenyl)propyl]-2, 4, 8,10-tetraoxospiro[5.5]undecane, and compounds in which all or a part of active methylol groups in the compounds are alkyl-etherified.

Examples of the benzocyclobutene compound include compounds described in JP 2005-60507 A.

Examples of the propargyl compound include compounds represented by the following formulae (b-9-1) to (b-9-2).

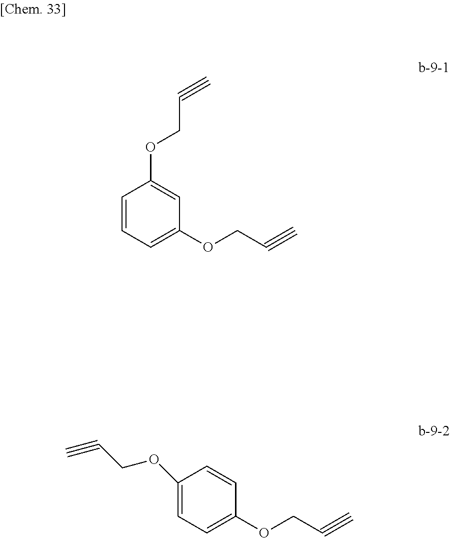

### [Content Ratio of Compound (B)]

The content ratio of the compound (B) in the present composition (1) is preferably 0.05 mass % or more, more preferably 10 mass or more, and still more preferably 20 mass % or more, and is preferably 90 mass % or less, more preferably 80 mass % or less, and still more preferably 50 mass % or less, for example, when the total solid content in the present composition (1) is regarded as 100 mass %.

The content ratio of the compound (B) within the above range is preferable from the viewpoint that, for example, the strength and heat resistance of a cured product obtained from the present composition (1) can be further improved.

When the total solid content of the polymer (A) and the compound (B) in the present composition (1) is regarded as 100 mass %, the content ratio of the compound (B) is preferably 1 mass % or more, more preferably 5 mass& or more, and still more preferably 10 mass& or more, and is preferably 99 mass& or less, more preferably 95 mass& or less, and still more preferably 90 mass % or less.

The content ratio of the compound (B) within the above range is preferable from the viewpoint that, for example, the toughness and heat resistance of a cured product obtained from the present composition (1) can be further improved.

### <<Second Composition>>

A second composition according to one embodiment of the present invention (hereinafter also referred to as “present composition (2)”) contains a polymer (A2) having a repeating structural unit represented by the following formula (3) (hereinafter also referred to as “repeating unit (3)”) and a repeating structural unit represented by the following formula (4) (hereinafter also referred to as “repeating unit (4)”), and a curable compound (B2) other than the polymer (A2). The present composition (2) may further contain other components such as a curing aid.

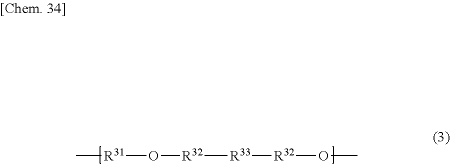

In the formula (3),
R³¹ represents a divalent organic group having 3 to 10 carbon atoms,
R³²'s independently represent a divalent substituted or unsubstituted aromatic hydrocarbon group, and
R³³ represents a hydrocarbon group having 1 to 20 carbon atoms to which two R³²'s and at least one group represented by a formula (a2) below are bonded,

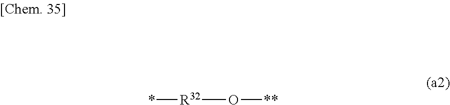

In the formula (a2),
* represents a linkage to the R³³,
** represents a bond to another structural unit in the polymer (A2), and
R³² has the same meaning as R³² in the formula (3).

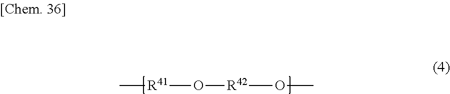

In the formula (4),
R⁴¹ represents a divalent organic group having 3 to 10 carbon atoms, and
R⁴² represents a divalent group containing a substituted or unsubstituted aromatic hydrocarbon group in a main chain, and an oxygen atom in the formula is directly bonded to the aromatic hydrocarbon group.

### <Polymer (A2)>

The polymer (A2) has the repeating unit (3) and the repeating unit (4).

In the repeating unit (3), R³¹ represents a divalent organic group having 3 to 10 carbon atoms. The divalent organic group having 3 to 10 carbon atoms is not particularly limited, and examples thereof include a phenyl group, a tolyl group, a xylyl group, and a naphthyl group. Among these, a xylyl group is preferable.

R³²'s in the repeating unit (3) independently represent a divalent substituted or unsubstituted aromatic hydrocarbon group. The details of the R³² are similar to those of R¹² in the repeating unit (1).

R³³ in the repeating unit (3) represents a hydrocarbon group having 1 to 20 carbon atoms in which at least one group represented by the following formula (a2) are bonded to the two R³²'s. The details of the R³³ and the group represented by the formula (a2) are similar to those of R¹² and the group represented by the formula (a1) in the repeating unit (1), respectively.

It is preferable that two or more of the repeating units (3) are contained in the polymer (A2) from the viewpoint of improving the glass transition temperature (Tg).

In the repeating unit (4), R⁴¹ represents a divalent organic group having 3 to 10 carbon atoms. The divalent organic group having 3 to 10 carbon atoms is not particularly limited, and examples thereof include a phenyl group, a tolyl group, a xylyl group, and a naphthyl group. Among these, a xylyl group is preferable.

R⁴² in the repeating unit (4) represents a divalent group containing a substituted or unsubstituted aromatic hydrocarbon group in a main chain. The details of the R⁴² are similar to those of R²² in the repeating unit (2).

When all structural units contained in the polymer (A2) are taken as 100 mol %, the content ratio of the repeating unit (3) is preferably 5 mol % or more and 95 mol % or less, more preferably 10 mol % or more and 90 mol % or less, and still more preferably 20 mol % or more and 80 mol % or less.

Further, when all structural units contained in the polymer (A2) are taken as 100 mol %, the content ratio of the repeating unit (4) is preferably 5 mol % or more and 95 mol % or less, more preferably 10 mol % or more and 90 mol % or less, and still more preferably 20 mol % or more and 80 mol % or less.

The polymer (A2) preferably has a group Y represented by the formula (y) (terminal group Y) at the terminal. The details of the terminal group Y are as described above.

When the terminal group Y is bonded to, for example, the repeating unit (3), the terminal group Y is bonded to O (oxygen atom) but is not bonded to R³¹. Similarly, when the terminal group Y is bonded to the repeating unit (4), the terminal group Y is bonded to O (oxygen atom) but is not bonded to R⁴¹.

The polymer (A2) may have another structural unit as necessary in addition to the repeating units (3) and (4) and the terminal group Y. Therefore, for example, the repeating units (3) may be bonded to each other, or the repeating unit (3) may be bonded to the repeating unit (4), the another structural unit, or the terminal group Y.

When the polymer (A2) has a plurality of repeating units (3), a plurality of R³¹'s may be the same as or different from each other. The same applies to R³² and R³³, the repeating unit (4), and the another structural unit.

Examples of the monomer from which the another structural unit is derived include compounds from which a structural unit containing a carbonate bond, a thiocarbonate bond, or a selenocarbonate bond is derived, such as diphenyl carbonate, diphenyl thiocarbonate, diphenyl selenocarbonate, phosgene, thiophosgene, or selenophosgene; dihydroxy compounds such as benzenedimethanol and cyclohexanedimethanol; phosphine oxide compounds such as bis(fluorophenyl)phenylphosphine oxide, bis(fluorophenyl)naphthylphosphine oxide, and bis(fluorophenyl)anthrylphosphine oxide; and dihalides of dicarboxylic acids such as phthalic acid dichloride, isophthalic acid dichloride, and terephthalic acid dichloride. One kind of these monomers may be used singly, or two or more kinds thereof may be used.

The method for synthesizing the polymer (A2) is not particularly limited, and a known method can be used, and for example, the polymer (A2) can be synthesized in the same manner as the polymer (A) described above.

The physical properties of the polymer (A2) are preferably similar to the physical properties of the polymer (A) described above.

The polymer (A2) used in the present composition (2) may be one or two or more kinds. The present composition (2) may be a mixture of two or more kinds of the polymers (A2).

In the case of using two or more kinds of the polymers (A2), for example, the polymer (A2) having a different molecular weight in the range of the molecular weight of the polymer (A2) can be mixed depending on, for example, desired physical properties.

The content ratio of the polymer (A2) in the present composition (2) is preferably 10 mass % or more, more preferably 20 mass % or more, and still more preferably 50 mass % or more, and is preferably 99.95 mass % or less, more preferably 90 mass or less, and still more preferably 80 mass % or less, for example, when the total solid content in the present composition (2) is regarded as 100 mass %. The content ratio of the polymer (A2) within the above range is preferable from the viewpoint that, for example, adhesiveness, heat resistance, curability, and electrical properties of a cured product obtained from the present composition (2) can be further improved.

### <Curable Compound (B2)>

The curable compound (B2) (hereinafter also referred to as “compound (B2)”) is a compound other than the polymer (A2), is a compound that cures by heat or irradiation with light (for example: visible light, ultraviolet light, near infrared light, or far infrared light), and may require a curing aid described below. Examples of such a compound (B2) include a vinyl compound, a maleimide compound, an allyl compound, an acrylic compound, a methacrylic compound, a thiol compound, an oxazine compound, a cyanate compound, an epoxy compound, an oxetane compound, a methylol compound, a benzocyclobutene compound, a propargyl compound, and a silane compound. Among these, from the viewpoint of, for example, compatibility and reactivity with the polymer (A2), particularly, at least one of a vinyl compound, a maleimide compound, and an allyl compound is preferable.

One kind of the compound (B2) may be used singly, or two or more kinds thereof may be used. More specific examples of the compound (B2) are similar to those of the compound (B) described above.

### [Content Ratio of Compound (B2)]

The content ratio of the compound (B2) in the present composition (2) is preferably 0.05 mass& or more, more preferably 10 mass % or more, and still more preferably 20 mass % or more, and is preferably 90 mass& or less, more preferably 80 mass % or less, and still more preferably 50 mass % or less, for example, when the total solid content in the present composition (2) is regarded as 100 mass %.

The content ratio of the compound (B2) within the above range is preferable from the viewpoint that, for example, the strength and heat resistance of a cured product obtained from the present composition (2) can be further improved.

When the total solid content of the polymer (A2) and the compound (B2) in the present composition (2) is regarded as 100 mass %, the content ratio of the compound (B2) is preferably 1 mass % or more, more preferably 5 mass& or more, and still more preferably 10 massy or more, and is preferably 99 mass& or less, more preferably 95 mass& or less, and still more preferably 90 mass % or less.

The content ratio of the compound (B2) within the above range is preferable from the viewpoint that, for example, the toughness and heat resistance of a cured product obtained from the present composition (2) can be further improved.

### <Other Components>

The present compositions (1) and (2) (hereinafter these are also collectively referred to simply as the “present composition”) may further contain other components as long as the effect of the present invention is not impaired, in addition to the polymer (A) and the compound (B).

Examples of the other components include a curing aid, a solvent, an additive for imparting various functions, an inorganic filler, an organic filler, and a polymer other than the polymer (A) or (A2). One kind of each of these other components may be used singly, or two or more kinds thereof may be used.

### [Curing Aid]

The present composition may contain a curing aid as necessary.

Examples of the curing aid include polymerization initiators such as a thermal radical or photoradical initiator, a cationic curing agent, and an anionic curing agent.

Examples of the thermal radical initiator include organic peroxides such as dicumyl peroxide, 1,1-di(t-butylperoxy)cyclohexane, di(t-butylperoxyisopropyl)benzene, 2,5-dimethyl-2,5-di(t-butylperoxy) hexine-3, and benzoyl peroxide; and azo compounds such as azobisbutyronitrile, 1,1′-azobis(1-acetoxy-1-phenylethane)], 2,2′-azobis(2,4-dimethylvaleronitrile), 1,1′-azobis(cyclohexane-1-carbonitrile), dimethyl-2,2′-azobis(isobutyrate), and 2,2′-azobis(2-methylbutyronitrile).

Examples of the cationic curing agent include phosphonium salts such as diallylyodonium salts, trialkylsulfonium salts, and butyltriphenylphosphonium thiocyanate having BF₄, PF₆, and SbF₆ as a counter anion, such as SP70, SP172, and CP66 manufactured by ADEKA CORPORATION, CI2855 and CI2823 manufactured by Nippon Soda Co., Ltd., SI100 and SI150 manufactured by SANSHIN CHEMICAL INDUSTRY CO., LTD.; and boron trifluoride.

Examples of the anionic curing agent include imidazole compounds such as 2-methylimidazole, 2-ethyl-4-methylimidazole, 2-undecylimidazole, 2-heptadecylimidazole, 2-phenylimidazole, 1-benzyl-2-methylimidazole, 1-cyanoethyl-2-methylimidazole, 1-cyanoethyl-2-ethyl-4-methylimidazole, 2-methylimidazolium isocyanurate, 2,4-diamino-6-[2-methylimidazolin-(1)]-ethyl-S-triazine, and 2,4-diamino-6-[2-ethyl-4-methylimidazolin-(1)]-ethyl-S-triazine; phosphorus compounds such as triphenylphosphine; and amine compounds such as 4,4′-diaminodiphenylmethane.

Examples of the curing aid when a silane compound is used as the compound (B) or (B2) include platinum group metal catalysts such as platinum-based catalysts such as platinum black, platinic chloride, chloroplatinic acid, a reaction product of chloroplatinic acid with monohydric alcohol, chloroplatinic acid-olefin complexes, and platinum bisacetoacetate; palladium-based catalysts; and rhodium-based catalyst; zinc benzoate, and zinc octylate.

Examples of the curing aid when an oxazine compound is used as the compound (B) or (B2) include phenol and derivatives thereof, cyanic acid ester, Brønsted acids such as p-toluenesulfonic acid, adipic acid, aromatic amine compounds such as p-toluenesulfonic acid ester, 4,4′-diaminodiphenylsulfone, and melamine, bases such as 2-ethyl-4-methylimidazole, and curing agents such as boron trifluoride and Lewis acid.

When the present composition contains a curing aid, the content ratio of the curing aid is preferably in a range in which the present composition is satisfactorily cured to obtain a cured product. Specifically, the content ratio of the curing aid is preferably 0.000001 parts by mass or more and more preferably 0.001 parts by mass or more, and is preferably 20 parts by mass or less and more preferably 10 parts by mass or less, with respect to 100 parts by mass of the total solid content of the polymer (A) or (A2) and the compound (B) or (B2)

### [Solvent]

The present composition may contain a solvent as necessary.

Examples of the solvent include amide-based solvents such as N, N-dimethylformamide; ester-based solvents such as Y-butyrolactone and butyl acetate; ketone-based solvents such as cyclopentanone, cyclohexanone, methyl ethyl ketone, and 2-heptanone; ether-based solvents such as 1,2-methoxyethane, anisole, and tetrahydrofuran, polyfunctional solvents such as 1-methoxy-2-propanol and propylene glycol methyl ether acetate; sulfone-based solvents such as dimethyl sulfoxide; methylene chloride, benzene, toluene, xylene, and trialkoxybenzene (number of carbon atoms of an alkoxy group; 1 to 4).

When the present composition contains a solvent, the content ratio of the solvent in the present composition is not particularly limited, but is preferably 0 parts by mass or more and 2000 parts by mass or less, and more preferably 0 parts by mass or more and 1000 parts by mass or less, for example, with respect to 100 parts by mass of the total solid content of the polymer (A) or (A2) and the compound (B) or (B2).

When the solubility of the polymer (A) or (A2) or the compound (B) or (B2) in the solvent is high, the content ratio of the solvent in the present composition may be 50 parts by mass or more and 200 parts by mass or less.

### [Additive]

Examples of the additive used for the purpose of imparting various functions include an antioxidant, a flame retardant, and an adhesion aid. Specific examples of the compound include a hindered phenolic compound, a phosphorus-based compound, a sulfur-based compound, a metal-based compound, and a hindered amine-based compound. Among these, a hindered phenolic compound is preferable.

The hindered phenolic compound is preferably a compound having a molecular weight of 500 or more. Examples of the hindered phenolic compound having a molecular weight of 500 or more include triethylene glycol-bis[3-(3-t-butyl-5-methyl-4-hydroxyphenyl)propionate], 1,6-hexanediol-bis[3-(3,5-di-t-butyl-4-hydroxyphenyl)propionate], 2,4-bis-(n-octylthio)-6-(4-hydroxy-3,5-di-t-butylanilino)-3,5-triazine, pentaerythritol tetrakis[3-(3,5-t-butyl-4-hydroxyphenyl)propionate], 1,1,3-tris[2-methyl-4-[3-(3,5-di-t-butyl-4-hydroxyphenyl)propionyloxy]-5-t-butylphenyl]butane, 2,2-thio-diethylene bis[3-(3,5-di-t-butyl-4-hydroxyphenyl)propionate], octadecyl-3-(3,5-di-t-butyl-4-hydroxyphenyl)propionate, N, N-hexamethylene bis(3,5-di-t-butyl-4-hydroxy-hydrocinnamamide), 1,3,5-trimethyl-2, 4,6-tris(3,5-di-t-butyl-4-hydroxybenzyl)benzene, tris-(3,5-di-t-butyl-4-hydroxybenzyl)-isocyanurate, 3,9-bis[2-[3-(3-t-butyl-4-hydroxy-5-methylphenyl)propionyloxy]-1,1-dimethylethyl]-2,4,8,10-tetraoxaspiro[5.5]undecane, 2,6-di-tert-butyl-p-cresol (BHT), 1,3,5-tris(3,5-di-tert-butyl-4-hydroxybenzyl)-1,3,5-triazine-2,4,6 (1H, 3H, 5H)-trione [manufactured by ADEKA CORPORATION, AO-020], 4,4′,4″-(1-methylpropanyl-3-ylidene)tris(6-tert-butyl-m-cresol) [manufactured by ADEKA CORPORATION, AO-030], 6,6′-di-tert-butyl-4,4′-butylidenedi-m-cresol [manufactured by ADEKA CORPORATION, AO-040], and 1, 3,5-tris(3,5-di-tert-butyl-4-hydroxyphenylmethyl)-2,4,6-trimethylbenzene [manufactured by ADEKA CORPORATION, AO-330].

Examples of the hindered amine-based compound include 2, 2, 6,6-tetramethyl-4-hydroxypiperidine-1-oxyl [manufactured by ADEKA CORPORATION, ADK STAB LA-7RD], IRGASTAB UV 10 (4,4′-[1,10-dioxo-1,10-decanediyl)bis(oxy)]bis[2,2,6,6-tetramethyl]-1-piperidinyloxy) (CAS. 2516-92-9) and TINUVIN 123 (4-hydroxy-2,2,6,6, -tetramethylpiperidine-N-oxyl) (all manufactured by BASF), FA-711HM and FA-712HM (2,2,6,6-tetramethylpiperidinyl methacrylate, manufactured by Showa Denko Materials Co., Ltd.), TINUVIN 111FDL, TINUVIN 144, TINUVIN 152, TINUVIN 292, TINUVIN 765, TINUVIN 770DF, TINUVIN 5100, SANOLLS-2626, CHIMASSORB 119FL, CHIMASSORB 2020 FDL, CHIMASSORB 944 FDL, and TINUVIN 622 LD (all manufactured by BASF), and LA-52, LA-57, LA-62, LA-63P, LA-68LD, LA-77Y, LA-77G, LA-81, LA-82 (1,2,2,6,6-pentamethyl-4-piperidyl methacrylate), and LA-87 (all manufactured by ADEKA CORPORATION).

When the present composition contains the additive, the content ratio of the additive is, for example, preferably 0.001 parts by mass or more and 10 parts by mass or less with respect to 100 parts by mass of the total solid content of the polymer (A) or (A2) and the compound (B) or (B2).

### [Inorganic Filler]

Examples of the inorganic filler include silicas such as natural silica, fused silica, and amorphous silica, white carbon, titanium white, aerosil, alumina, talc, natural mica, synthetic mica, clay, barium sulfate, E-glass, A-glass, C-glass, L-glass, D-glass, S-glass, and S-glass, M-glass G20.

When the present composition contains an inorganic filler, the content ratio of the inorganic filler is, for example, preferably 0.1 parts by mass or more and 300 parts by mass or less with respect to 100 parts by mass of the total solid content of the polymer (A) or (A2) and the compound (B) or (B2). The inorganic filler may be in a state of being dispersed in the solvent by the polymer (A).

### [Organic Filler]

Examples of the organic filler include fluorine-based resins, such as polytetrafluoroethylene (PTFE), a polyperfluoroalkoxy resin, a polyfluorinated ethylene propylene resin, and a polytetrafluoroethylene-polyethylene copolymer, or fluorine-based particles, polystyrene resins or particles, rubber-like resins, such as polybutadiene and a styrene-butadiene resin, or particles, and hollow particles having divinylbenzene or divinylbiphenyl as a shell.

When the present composition contains an organic filler, the content ratio of the organic filler is, for example, preferably 0.1 parts by mass or more and 300 parts by mass or less with respect to 100 parts by mass of the total solid content of the polymer (A) or (A2) and the compound (B) or (B2). The organic filler may be in a state of being dispersed in the solvent by the polymer (A) or (A2).

### [Method for Preparing Present Composition]

The present composition can be prepared, for example, by uniformly mixing the polymer (A) or (A2), the compound (B) or (B2), and the other components. There is no particular limitation in, for example, the order of mixing and mixing conditions in this case, and a conventionally known mixer may be used for mixing.

### <<Cured Product>>

A cured product according to one embodiment of the present invention (hereinafter also referred to as “present cured product”) is a cured body of the present composition, and is obtained by curing the present composition.

The present cured product may be, for example, a partially cured product of the present composition obtained by drying the solvent from the present composition.

A method of curing the present composition is not particularly limited, but usually, a method of thermally curing the present composition by heating or a method of photocuring the present composition by irradiation with light is used. These methods can also be used in combination.

In the case of thermal curing, the heating temperature is preferably 50° C. or higher, more preferably 100° C. or higher, and still more preferably 120° C. or higher, and is preferably 250° C. or lower and more preferably 220° C. or lower. The heating time is preferably 0.1 hours or longer and more preferably 0.5 hours or longer, and is preferably 36 hours or shorter and more preferably 5 hours or shorter.

In the case of photocuring, examples of the light used for irradiation include visible light, ultraviolet light, near infrared light, and far infrared light.

### Glass Transition Temperature (Tg)

The lower limit of Tg of the present cured product is preferably 100° C. and more preferably 110° C., and the upper limit thereof is, for example, 300° C. When Tg is in the above range, melt molding can be more easily performed, and a cured product excellent in heat resistance can be easily obtained.

Tg is measured by preparing a test piece (width: 3 mm×length: 1 cm), measuring Tg at a temperature increase rate of 10° C./min from 50° C. to 300° C. at 1 Hz under nitrogen using a dynamic viscoelasticity measuring device (manufactured by Seiko Instruments Inc., model number: “EXSTAR4000”), and measuring Tg at a temperature increase rate of 10° C./min to 300° C. at 1 Hz, and tan δ at this time is taken as the glass transition temperature (Tg). When two or more tan δ values are present, the lowest value is defined as Tg.

The dissipation factor (tan δ) of the present cured product is preferably 0.0025 or less, more preferably 0.0018 or less, and still more preferably 0.0015 or less, and the lower limit thereof is not particularly limited, and is preferably 0.0005 or more, from the viewpoint that, for example, the transmission loss can be reduced. Specifically, the dissipation factor can be measured by the method described in the following Examples.

The linear expansion coefficient (CTE) of the present cured product is preferably less than 70 ppm/K, more preferably 50 ppm/K or less, still more preferably 20 ppm/K or less, and the lower limit thereof is not particularly limited, but is preferably 17 ppm/K or more. Specifically, the linear expansion coefficient can be measured by the method described in the following Examples. When the CTE is within the above range, the difference in linear expansion coefficient between the present cured product and the metal type of, for example, a copper wire can be reduced.

The shape of the present cured product is not particularly limited, and may be a shape suitable for, for example, use application and purpose, and examples thereof include a film. For example, the present composition can be obtained as a film-shaped cured product by melt-molding or cast-molding the present composition.

The thickness of the film is not particularly limited, and may be appropriately selected according to a desired use application, but is, for example, 10 μm or more and preferably 30 μm or more, and is, for example, 2 mm or less and preferably 1 mm or less.

### <<Laminated Body>>

A laminated body according to one embodiment of the present invention (hereinafter also referred to as “present laminated body”) includes, for example, a substrate and a cured product layer formed using the present composition.

The present laminated body may include two or more layers of substrates, two or more layers of cured product layers, or conventionally known layers other than the substrate and the cured product layer. When the present laminated body has two or more layers of substrates, cured product layers, or other layers, these layers may be the same layer (plate) or different layers (plates).

The present laminated body may be a prepreg obtained by impregnating a substrate such as a glass cloth, an aramid nonwoven fabric, or a polyester nonwoven fabric with the present composition and curing the resultant.

Examples of the substrate include an inorganic substrate, a metal substrate, and a resin substrate from the viewpoint of adhesiveness and practical use. The substrate may be a prepreg.

Examples of the inorganic substrate include inorganic substrates containing, for example, silicon, silicon carbide, silicon nitride, alumina, glass, or gallium nitride as a component.

Examples of the metal substrate include metal substrates containing, for example, copper, aluminum, gold, silver, nickel, or palladium as a component.

Examples of the resin substrate include resin substrates containing, for example, a liquid crystal polymer, polyimide, polyphenylene sulfide, polyether ether ketone, polyamide (nylon), polyethylene terephthalate, polyethylene naphthalate, a cycloolefin polymer, or polyolefin as a component.

The cured product layer can be formed, for example, by curing according to the method described in the section of the cured product.

The thickness of the cured product layer is not particularly limited, and is, for example, 1 μm to 3 mm.

### <<Use Application>>

The polymer (A), the present composition, the present cured product, and the present laminated body can be suitably used for, for example, structural materials used in the transport machine industry such as the aircraft industry and the automobile industry, electrical and electronic materials used in the electrical and electronic industry. Specifically, for example, the polymer (A), the present composition, the present cured product, and the present laminated body can be suitably used for a sealing material for an electrical and electronic component, an interlayer insulating film, and a stress relaxation primer; laminate use applications (for example: a prepreg, a copper-clad laminate, a (multilayer) printed wiring board, an interlayer adhesive, a solder resist, and a solder paste); adhesive use applications (for example: an adhesive sheet for forming an insulating layer, a thermally conductive adhesive, and an adhesive sheet); structural adhesives/prepregs used for various structural materials; various coatings and optical component use applications (for example: optical films such as wave plates and retardation plates, various special lenses such as conical lenses, spherical lenses, and cylindrical lenses, and lens arrays), and insulating films for printed wiring boards.

### <<Electronic Component>>

An electronic component according to one embodiment of the present invention includes the present cured product or the present laminated body. The electronic component may include two or more present cured products or two or more present laminated bodies, or may include one or more present cured products and one or more present laminated bodies. When the electronic component includes two or more present cured products or present laminated bodies, these present cured products or present laminated bodies may be the same as or different from each other.

Examples of the electronic component include a circuit board, a semiconductor package, and a display board. The present cured product (cured film) can be used as a prepreg, a copper-clad laminate, a printed wiring board, an adhesive sheet for forming an insulating layer, a surface protective film, a rewiring layer, or a planarization film of these electronic components. Since the present cured product can maintain insulation even under high temperature and high humidity, the electronic component can protect a circuit pattern from an external environment such as dust, heat, and moisture, has excellent insulation reliability between circuit patterns, and can stably operate for many years.

For example, the rewiring layer can be formed by repeating filling of the pattern formed on the present cured product (cured film) with a metal, for example, by plating, further laminating the present cured product (cured film) as necessary, and filling with a metal, whereby an electronic component having a substrate and a rewiring layer including a metal wire and an insulating film can be produced.

### EXAMPLES

Hereinafter, the present invention will be described in more detail based on Examples, but the present invention is not limited to these Examples.

### Synthesis Example 1

In a four-neck separable flask equipped with a stirrer, 2,2-bis(4-hydroxy-3 methylphenyl)propane (51.27 g), α,α,α′-tris(4-hydroxyphenyl)-1-ethyl-4-isopropylbenzene (21.23 g), 4,6-dichloro-2-phenylpyrimidine (41.43 g), and potassium carbonate (51.31 g) were weighed, N-methyl-2-pyrrolidone (113.92 g) was added thereto, and the mixture was allowed to react at 130° C. for 6 hours in a nitrogen atmosphere. After the reaction, chloromethylstyrene (38.55 g) was added dropwise while the vessel was cooled to 10° C., and then the reaction was allowed to proceed at 65° C. for 6 hours. After removal of the salt by filtration from a liquid obtained by adding N-methyl-2-pyrrolidone (258.1 g) for dilution to the obtained reaction liquid, the obtained solution was added to methanol (4,960 g). The precipitated solid was filtered off, and the solid was washed with a small amount of methanol, filtered off again to recover the solid, and then dried at 80° C. for 12 hours under reduced pressure using a vacuum dryer to obtain a polymer (A-1) represented by the following formula (yield amount: 112.84 g, yield percentage: 91%).

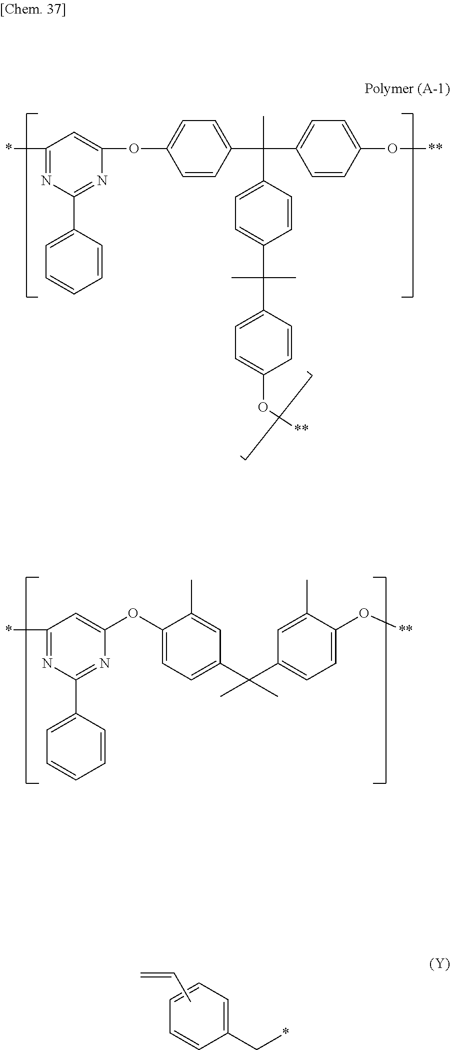

The formula represents that the polymer (A-1) is a polymer having the above structural unit. In the formula, * represents being bonded to any **, and the polymer (A-1) has a group represented by the formula (Y) at a polymer terminal. The same applies to the following synthesis examples.

### Synthesis Example 2

A polymer (A-2) represented by the following formula was obtained (yield amount: 108.17 g, yield percentage: 89%) by performing synthesis using a procedure similar to that in Synthesis Example 1 except that the raw materials used were changed to 2,2-bis(4-hydroxy-3-methylphenyl)propane (51.27 g), 4,4′-(2-hydroxybenzylidene)bis(2, 3, 6-trimethylphenol) (18.78 g), 4,6-dichloro-2-phenylpyrimidine (41.43 g), potassium carbonate (51.31 g), and chloromethylstyrene (38.55 g).

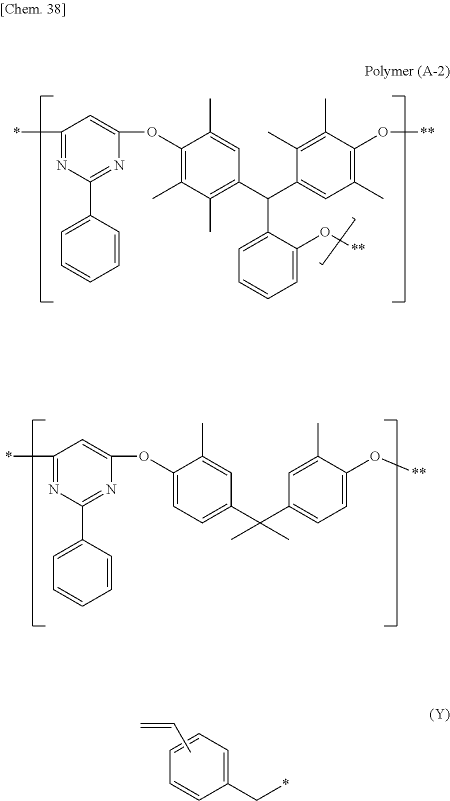

### Synthesis Example 3

A polymer (A-3) represented by the following formula was obtained (yield amount: 106.28 g, yield percentage: 90%) by performing synthesis using a procedure similar to that in Synthesis Example 1 except that the raw materials used were changed to 2, 2-bis(4-hydroxy-3-methylphenyl)propane (51.27 g), 1,1,1-tris(4-hydroxyphenyl) ethane (15.32 g), 4, 6-dichloro-2-phenylpyrimidine (41.43 g), potassium carbonate (51.31 g), and chloromethylstyrene (38.55 g).

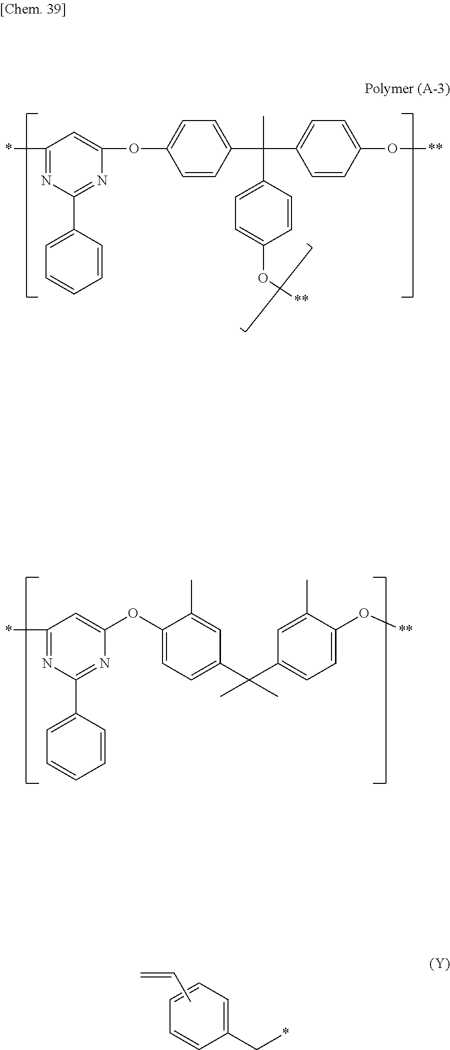

### Synthesis Example 4

A polymer (A-4) represented by the following formula was obtained (yield amount: 104.48 g, yield percentage: 89%) by performing synthesis using a procedure similar to that in Synthesis Example 1 except that the raw materials used were changed to 2, 2-bis(4-hydroxy-3-methylphenyl)propane (51.27 g), tris(4-hydroxyphenyl)methane (14.62 g), 4,6-dichloro-2-phenylpyrimidine (41.43 g), potassium carbonate (51.31 g), and chloromethylstyrene (38.55 g).

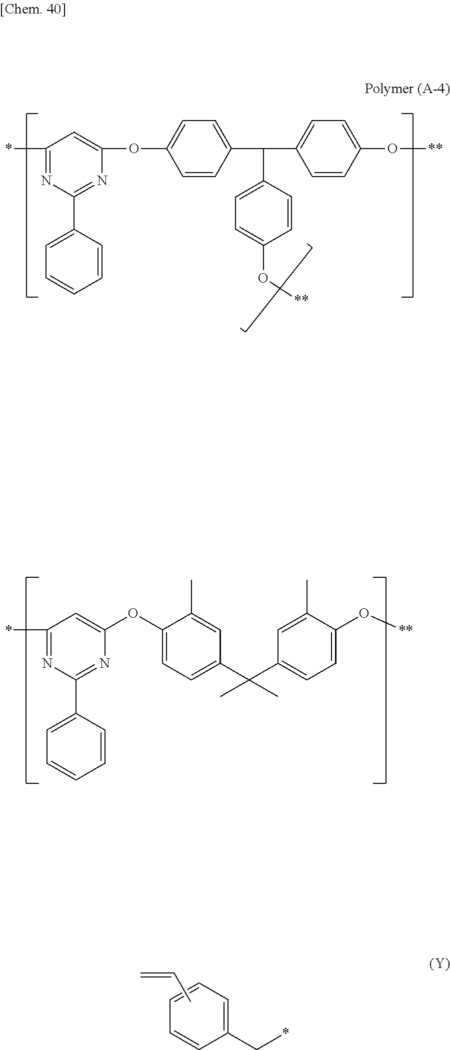

### Synthesis Example 5

A polymer (A-5) represented by the following formula was obtained (yield amount: 118.31 g, yield percentage: 91%) by performing synthesis using a procedure similar to that in Synthesis Example 1 except that the raw materials used were changed to 2, 2-bis(4-hydroxy-3-methylphenyl)propane (51.27 g), 1, 1, 1-tris(2-methyl-4-hydroxy-5-tert-butylphenyl)butane (27.24 g), 4,6-dichloro-2-phenylpyrimidine (41.43 g), potassium carbonate (51.31 g), and chloromethylstyrene (38.55 g).

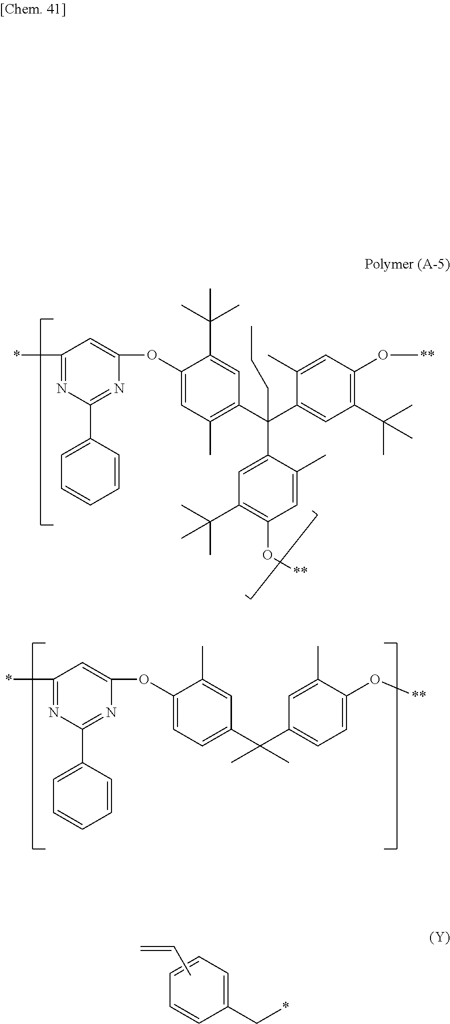

### Synthesis Example 6

A polymer (A-6) represented by the following formula was obtained (yield amount: 121.50 g, yield percentage: 88%) by performing synthesis using a procedure similar to that in Synthesis Example 1 except that the raw materials used were changed to 2,2-bis(4-hydroxy-3-methylphenyl)propane (51.27 g), 4,4′,4″,4′″-(propane-2,2-diylbis(cyclohexane-4, 1, 1-triyl)tetraphenol (28.84 g), 4, 6-dichloro-2-phenylpyrimidine (41.43 g), potassium carbonate (55.98 g), and chloromethylstyrene (49.15 g).

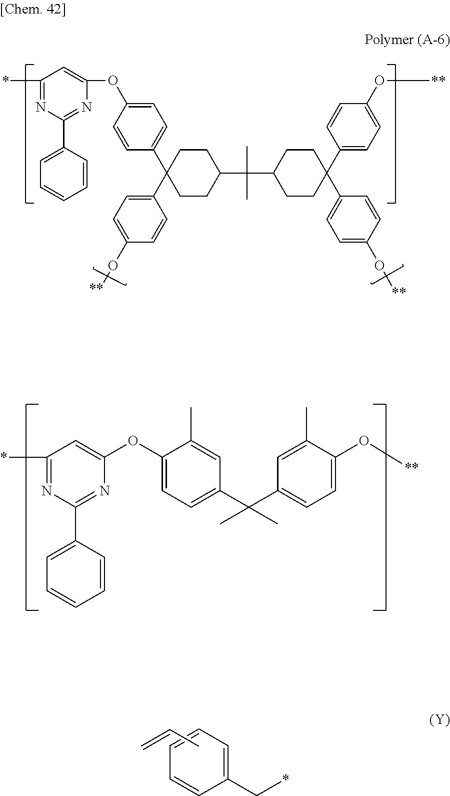

### Synthesis Example 7

A polymer (A-7) represented by the following formula was obtained (yield amount: 110.00 g, yield percentage: 92%) by performing synthesis using a procedure similar to that in Synthesis Example 1 except that the raw materials used were changed to 2,2-bis(4-hydroxy-3-methylphenyl)propane (57.68 g), 1,1,1-tris(2-methyl-4-hydroxy-5-tert-butylphenyl)butane (13.62 g), 4,6-dichloro-2-phenylpyrimidine (41.43 g), potassium carbonate (48.98 g), and chloromethylstyrene (33.25 g). The polymer (A-7) is a polymer having a similar structure except that the content ratio of each repeating unit in the polymer (A-5) is different.

### Synthesis Example 8

A polymer (A-8) represented by the following formula was obtained (yield amount: 141.97 g, yield percentage: 88%) by performing synthesis using a procedure similar to that in Synthesis Example 1 except that the raw materials used were changed to 2, 2-bis(4-hydroxy-3-methylphenyl)propane (32.04 g), 1, 1, 1-tris(2-methyl-4-hydroxy-5-tert-butylphenyl)butane (68.10 g), 4,6-dichloro-2-phenylpyrimidine (41.43 g), potassium carbonate (58.31 g), and chloromethylstyrene (54.45 g). The polymer (A-8) is a polymer having a similar structure except that the content ratio of each repeating unit in the polymer (A-5) is different.

### Synthesis Example 9

A polymer (A-9) represented by the following formula was obtained (yield amount: 112.84 g, yield percentage: 89%) by performing synthesis using a procedure similar to that in Synthesis Example 1 except that the raw materials used were changed to 4,4′-dihydroxy-2,2′,3,3′,5,5′-hexamethylbiphenyl (54.07 g), α,α,α′-tris(4-hydroxyphenyl)-1-ethyl-4-isopropylbenzene (21.23 g), 4, 6-dichloro-2-phenylpyrimidine (41.43 g), potassium carbonate (51.31 g), and chloromethylstyrene (38.55 g).

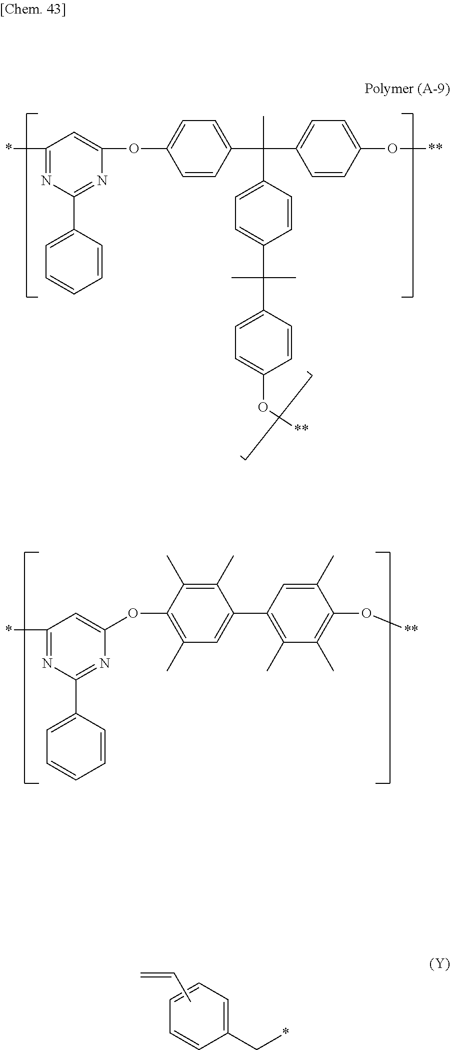

### Synthesis Example 10

A polymer (A-10) represented by the following formula was obtained (yield amount: 97.96 g, yield percentage: 88%) by performing synthesis using a procedure similar to that in Synthesis Example 1 except that the raw materials used were changed to 9, 9-bis(4-hydroxy-3-methylphenyl) fluorene (56.77 g), α,α,α′-tris(4-hydroxyphenyl)-1-ethyl-4-isopropylbenzene (15.92 g), 4,6-dichloro-2-phenylpyrimidine (31.07 g), potassium carbonate (38.48 g), and chloromethylstyrene (28.91 g).

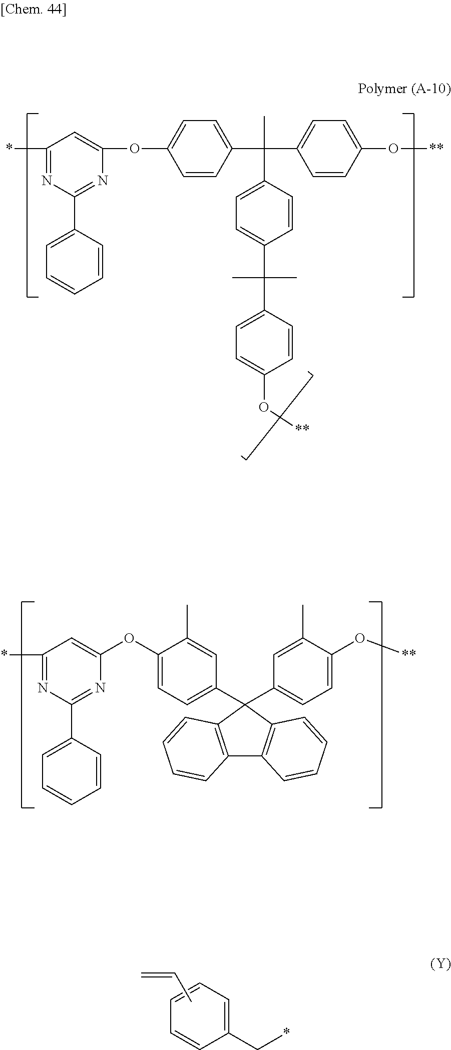

### Synthesis Example 11

A polymer (A-11) represented by the following formula was obtained (yield amount: 98.83 g, yield percentage: 92%) by performing synthesis using a procedure similar to that in Synthesis Example 1 except that the raw materials used were changed to 4, 4′-(cyclododecane-1,1-diyl)diphenol (52.88 g), α,α,α′-tris(4-hydroxyphenyl)-1-ethyl-4-isopropylbenzene (15.92 g), 4,6-dichloro-2-phenylpyrimidine (31.07 g), potassium carbonate (38.48 g), and chloromethylstyrene (28.91 g).

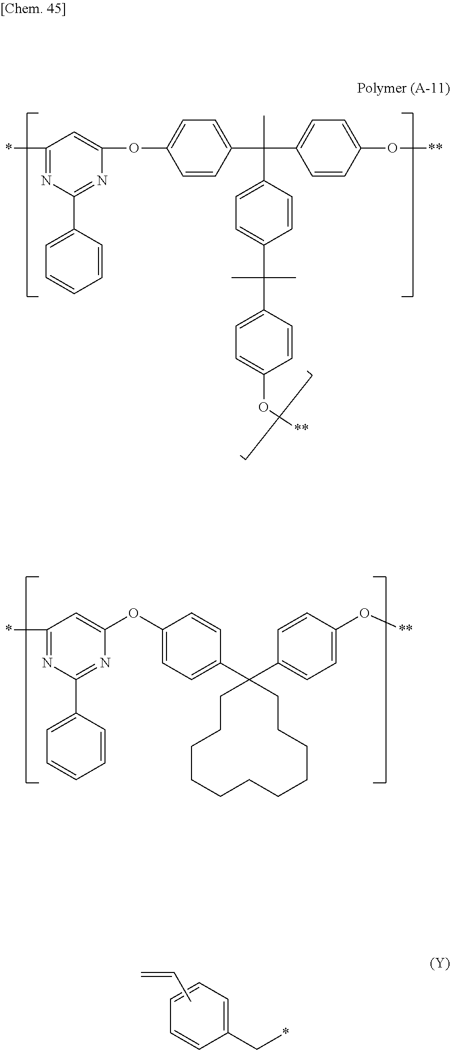

### Synthesis Example 12

A polymer (A′-12) represented by the following formula was obtained (yield amount: 100.40 g, yield percentage: 92%) by performing synthesis using a procedure similar to that in Synthesis Example 1 except that the raw materials used were changed to 2,2-bis(4-hydroxy-3-methylphenyl)propane (64.09 g), 4,6-dichloro-2-phenylpyrimidine (41.43 g), potassium carbonate (46.65 g), and chloromethylstyrene (27.95 g).

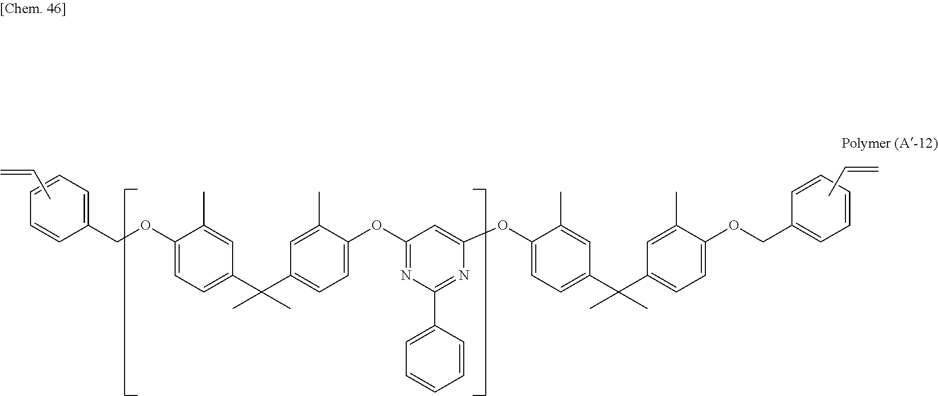

### Synthesis Example 13

A polymer (A′-13) represented by the following formula was obtained (yield amount: 93.06 g, yield percentage: 89%) by performing synthesis using a procedure similar to that in Synthesis Example 1 except that the raw materials used were changed to 2, 2-bis(4-hydroxy-3-methylphenyl)propane (64.09 g), 4,6-dichloro-2-phenylpyrimidine (31.08 g), 4,6-dichloropyrimidine (6.86 g), potassium carbonate (46.65 g), and chloromethylstyrene (22.01 g).

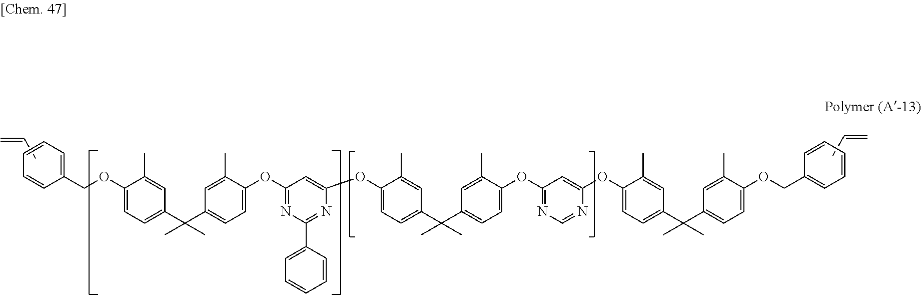

### Synthesis Example 14

A polymer (A′-14) represented by the following formula was obtained by performing synthesis using a procedure similar to that in production example described in JP 2020-200425 A except that the raw material used was changed to 1,1,1-tris(2-methyl-4-hydroxy-5-tert-butylphenyl)butane.

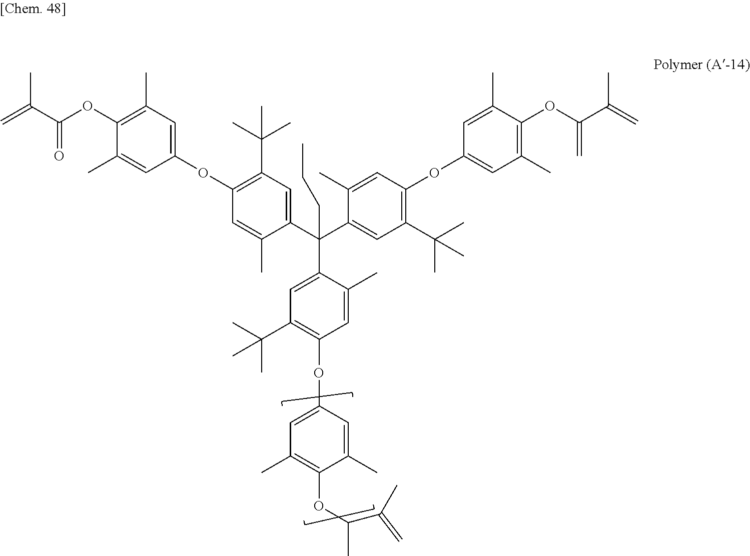

### Synthesis Example 15

A polymer (A-15) represented by the following formula was obtained (yield amount: 133.27 g, yield percentage: 88%) by performing synthesis using a procedure similar to that in Synthesis Example 1 except that the raw materials used were changed to 2, 2-bis(4-hydroxy-3-methylphenyl)propane (51.27 g), 4, 4′,4″,4′″-(propane-2,2-diylbis(cyclohexane-4, 1, 1-triyl)tetrakis(2-methylphenol) (31.63 g), 4, 6-dichloro-2-phenylpyrimidine (41.43 g), potassium carbonate (55.98 g), and chloromethylstyrene (49.15 g).

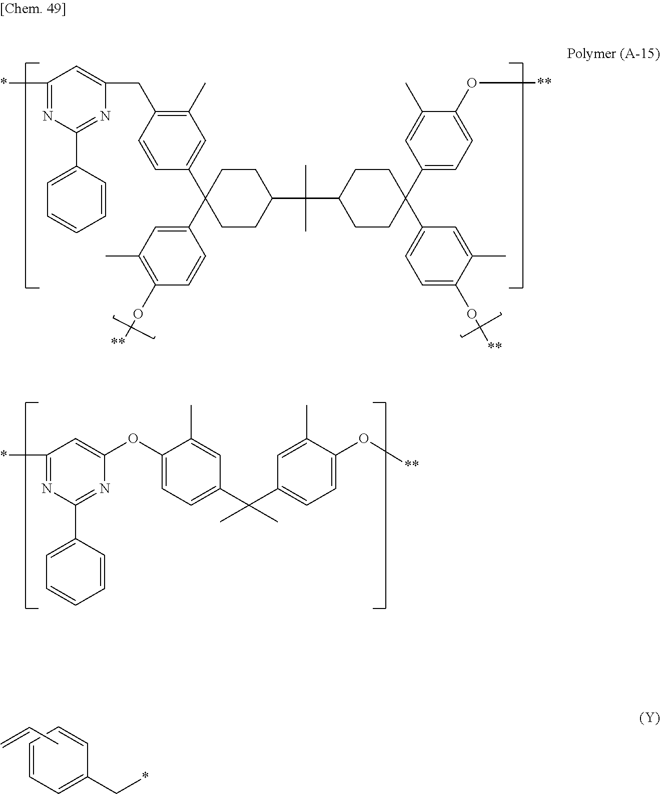

### [Weight Average Molecular Weight (Mw) and Number Average Molecular Weight (Mn)]

The weight average molecular weight (Mw) and the number average molecular weight (Mn) of the polymers synthesized in Synthesis Examples 1 to 15 and SA-9000 used in comparative examples described below were measured under the following conditions using a GPC apparatus (“HLC-8320” manufactured by TOSOH CORPORATION). The results are shown in Table 1.
Column: one obtained by connecting “TSKgel α-M” manufactured by TOSOH CORPORATION to “TSKgel guard column α” manufactured by TOSOH CORPORATION
Developing solvent: N-methyl-2-pyrrolidone
Column temperature: 40° C.
Flow rate: 1.0 mL/min
Sample concentration: 0.75 mass %
Sample injection amount: 50 μL
Detector: refractometer
Standard substance: monodisperse polystyrene
Concentration of measurement sample: 0.1 mass %

### <Glass Transition Temperature (Tg) of Polymer>

A varnish for evaluation was prepared by mixing 100 parts by mass of a polymer to be measured (each of the polymers synthesized in Synthesis Examples 1 to 15 and SA-9000), 0.5 parts by mass of PERCUMYL D (manufactured by NOF CORPORATION), and 100 parts by mass of toluene. Subsequently, the prepared varnish for evaluation was applied onto a copper foil (model number: CF-T49A-DS-HD2, manufactured by Fukuda Metal Co., Ltd.) using a baker-type applicator (gap: 75 μm), and dried at 100° C. for 5 minutes to form a coating film. A copper foil (model number: CF-T49A-DS-HD2, manufactured by Fukuda Metal Co., Ltd.) was overlaid on the obtained coating film, and vacuum-pressed at 150° C. for minutes, and then fired at 200° C. for 2 hours under nitrogen to prepare a cured film with a copper foil. The prepared cured film with a copper foil was immersed in a 40 mass % iron chloride solution to remove the copper foil from the cured film with a copper foil, then washed with water, and dried at 80° C. for 30 minutes to prepare a film for measuring a glass transition temperature (Tg) having a thickness of 50 μm.

A test piece (width: 3 mm× length: 1 cm) was cut out from the prepared film for measuring Tg, and measured at a temperature increase rate of 10° C./min from 50° C. to 300° C. at 1 Hz using a dynamic viscoelasticity measuring device (manufactured by Seiko Instruments Inc., model number: “EXSTAR4000”), and tan δ at this time was taken as the glass transition temperature (Tg). The results are shown in Table 1.

### <Dissipation Factor>

A test piece (width: 6 cm×length: 6 cm) was cut out from a cured film prepared in the same manner as the film for measuring Tg, and the dissipation factor of the test piece at 10 GHz was measured using a cavity resonator method (permittivity measurement system TE mode resonator manufactured by AET, Inc.). A case where the dissipation factor was 0.0025 or less was evaluated as “O”, and a case where the dissipation factor was more than 0.0025 was evaluated as “X”. The results are shown in Table 1.

### <Peel Strength of Polymer>

A varnish for evaluation was prepared by mixing 100 parts by mass of a polymer to be measured (each of the polymers synthesized in Synthesis Examples 1 to 15 and SA-9000), 0.5 parts by mass of PERCUMYL D (manufactured by NOF CORPORATION), and 100 parts by mass of toluene. Subsequently, the prepared varnish for evaluation was applied onto a copper foil (model number: CF-V9S-SV, manufactured by Fukuda Metal Co., Ltd.) using a baker-type applicator (gap: 75 μm), and heated at 100° C. for 5 minutes, and then dried at 130° C. for 5 minutes to form a coating film. A copper foil (model number: CF-V9S-SV, manufactured by Fukuda Metal Co., Ltd.) was overlaid on the obtained coating film, and vacuum-pressed at 150° C. for 5 minutes, and then fired at 200° C. for 2 hours under nitrogen to prepare a cured film with a copper foil (copper foil: 18 μm, cured film: 10 μm), and the cured film was used as a sample for peel strength.

A test piece (width: 5 mm×length: 10 cm) was cut out from the prepared sample for peel strength, a copper foil with a cured film (a laminated portion of one copper foil and a cured film in the sample for peel strength) was pulled in a 90-degree direction under a condition of 500 mm/min by using “Instron 5567” manufactured by Instron, and the peel strength was measured in accordance with “IPC-TM-650 2.4.9”. A case where the peel strength was 0.70 N/mm or more was evaluated as “O”, and a case where the peel strength was less than 0.70 N/mm was evaluated as “X”. The results are shown in Table 1.

TABLE 1

| | Example | | | | | |
|---|---|---|---|---|---|---|
| | Synthesis | Synthesis | Synthesis | Synthesis | Synthesis | Synthesis |
| | Example | Example | Example | Example | Example | Example |
| Resin | 1 | 2 | 3 | 4 | 5 | 6 |
| Mn | 1700 | 1700 | 2500 | 2400 | 2000 | 3300 |
| Mw | 7100 | 4200 | 11300 | 10500 | 5900 | 19400 |
| Mw/Mn | 4.2 | 2.4 | 4.5 | 4.4 | 3.0 | 5.8 |
| Tg(° C.) | 182 | 175 | 170 | 168 | 172 | 189 |
| Peel | ◯ | ◯ | ◯ | ◯ | ◯ | ◯ |
| strength | | | | | | |
| Dissipation | ◯ | ◯ | ◯ | ◯ | ◯ | ◯ |
| factor | | | | | | |

| | Example | | | | | |
|---|---|---|---|---|---|---|
| | Synthesis | Synthesis | Synthesis | Synthesis | Synthesis | Synthesis |
| | Example | Example | Example | Example | Example | Example |
| Resin | 7 | 8 | 9 | 10 | 11 | 15 |
| Mn | 1800 | 3200 | 1600 | 1800 | 1800 | 2000 |
| Mw | 4100 | 21700 | 6500 | 7400 | 7500 | 17900 |
| Mw/Mn | 2.3 | 6.8 | 4.0 | 4.1 | 4.2 | 9.0 |
| Tg(° C.) | 165 | 190 | 178 | 185 | 187 | 195 |
| Peel | ◯ | ◯ | ◯ | ◯ | ◯ | ◯ |
| strength | | | | | | |
| Dissipation | ◯ | ◯ | ◯ | ◯ | ◯ | ◯ |
| factor | | | | | | |

| | Comparative Example | | | |
|---|---|---|---|---|
| | Synthesis | Synthesis | | Synthesis |
| | Example | Example | | Example |
| Resin | 12 | 13 | SA9000 | 14 |
| Mn | 1500 | 1400 | 1700 | 1800 |
| Mw | 3300 | 3100 | 4000 | 5500 |
| Mw/Mn | 2.2 | 2.2 | 2.4 | 3.0 |
| Tg(° C.) | 155 | 150 | 174 | 193 |
| Peel | ◯ | ◯ | X | X |
| strength | | | | |
| Dissipation | ◯ | ◯ | X | X |
| factor | | | | |

### Examples 1 to 23 and Comparative Examples 1 to 8

Respective components described in the column of composition type shown in Tables 2-1 and 2-2 (hereafter these are collectively referred to as “Table 2”) were mixed with a mixing rotor to have the ratio (parts by mass) described in the column of composition blending ratio, and the concentration was adjusted with toluene so that the concentration of the solid content was 50 parts by mass to prepare a composition.

### Preparation of Cured Film

Each of the compositions obtained in the above examples and comparative examples was applied onto a copper foil (model number: CF-T49A-DS-HD2, manufactured by Fukuda Metal Co., Ltd.) using a baker-type applicator (gap: 125 μm), and heated at 100° C. for 5 minutes, and then dried at 140° C. for 5 minutes to form a coating film. A copper foil (model number: CF-T49A-DS-HD2, manufactured by Fukuda Metal Co., Ltd.) was overlaid on the obtained coating film, and vacuum-pressed at 160° C. for 10 minutes, and then fired at 200° C. for 2 hours under nitrogen to prepare a cured film with a copper foil (copper foil: 18 μm, cured film: 50 to 100 μm). The obtained cured film with a copper foil was immersed in a 40 mass& iron chloride solution to remove the copper foil, then washed with water, and dried in an oven at 80° C. for 30 minutes to prepare a cured film having a thickness of 50 μm.

### <Glass Transition Temperature (Tg)>

A test piece (width: 3 mm×length: 1 cm) was cut out from the prepared cured film, and measured at a temperature increase rate of 10° C./min from 50° C. to 300° C. at 1 Hz using a dynamic viscoelasticity measuring device (manufactured by Seiko Instruments Inc., “EXSTAR4000”), and tan δ at this time was taken as the glass transition temperature (Tg). The results are shown in Table 2. When two or more tan δ values were present, the lowest value was defined as Tg.

### <Dissipation Factor>

A test piece (width: 6 cm×length: 6 cm) was cut out from the prepared cured film, and a dissipation factor of the test piece at 10 GHz was measured using a cavity resonator method (permittivity measurement system TE mode resonator, manufactured by AET, Inc). A case where the dissipation factor was 0.0025 or less was evaluated as “O”, and a case where the dissipation factor was more than 0.0025 was evaluated as “X”. The results are shown in Table 2.

### <Peel Strength>

A varnish for evaluation was prepared by mixing 70 parts by mass of a polymer (each of the polymers synthesized in Synthesis Examples 1 to 15 and SA-9000), 30 parts of TAIC or DVB960, 0.5 parts by mass of PERCUMYL D (manufactured by NOF CORPORATION), and 100 parts by mass of toluene. Subsequently, the prepared varnish for evaluation was applied onto a copper foil (model number: CF-V9S-SV, manufactured by Fukuda Metal Co., Ltd.) using a baker-type applicator (gap: 125 μm), and heated at 100° C. for 5 minutes, and then dried at 130° C. for 5 minutes to form a coating film. A copper foil (model number: CF-V9S-SV, manufactured by Fukuda Metal Co., Ltd.) was overlaid on the obtained coating film, and vacuum-pressed at 150° C. for 5 minutes, and then fired at 200° C. for 2 hours under nitrogen to prepare a cured film with a copper foil (copper foil: 18 μm, cured film: 10 μm), and the cured film was used as a sample for peel strength.

A test piece (width: 5 mm×length: 10 cm) was cut out from the prepared sample for peel strength, a copper foil with a cured film (a laminated portion of one copper foil and a cured film in the sample for peel strength) was pulled in a 90-degree direction under a condition of 500 mm/min by using “Instron 5567” manufactured by Instron, and the peel strength was measured in accordance with “IPC-TM-650 2.4.9”. A case where the peel strength was 0.70 N/mm or more was evaluated as “O”, and a case where the peel strength was less than 0.70 N/mm was evaluated as “X”. The results are shown in Table 2.

### <Linear Expansion Coefficient (CTE)>

A varnish for evaluation was prepared by mixing 70 parts by mass of a polymer (each of the polymers synthesized in Synthesis Examples 1 to 15 and SA-9000), 30 parts of TAIC or DVB960, 0.5 parts by mass of PERCUMYL D (manufactured by NOF CORPORATION), and 100 parts by mass of toluene. Subsequently, the prepared varnish for evaluation was applied onto a copper foil (model number: CF-T49A-DS-HD2, manufactured by Fukuda Metal Co., Ltd.) using a baker-type applicator (gap: 125 μm), and heated at 100° C. for 5 minutes, and then dried at 140° C. for 5 minutes to form a coating film. A copper foil (model number: CF-T49A-DS-HD2, manufactured by Fukuda Metal Co., Ltd.) was overlaid on the obtained coating film, and vacuum-pressed at 160° C. for 10 minutes, and then fired at 200° C. for 2 hours under nitrogen to prepare a cured film with a copper foil (copper foil: 18 μm, cured film: 50 to 100 μm). The prepared cured film with a copper foil was immersed in a 40 mass % iron chloride solution to remove the copper foil from the cured film with a copper foil, then washed with water, and dried at 80° C. for 30 minutes to prepare a film for measuring CTE.

The linear expansion coefficient of the prepared film for measuring CTE was measured using an SSC-5200 TMA measuring apparatus manufactured by Seiko Instruments Inc. At this time, the linear expansion coefficient was calculated from the slope of the TMA curve between 8° and 120° C. when the film for measuring CTE was heated at 5° C./min to a temperature 20° C. higher than its glass transition temperature and then cooled. A case where the CTE was less than 70 ppm/K was evaluated as “O”, and a case where the CTE was 70 ppm or more was evaluated as “X”. The results are shown in Table 2.

TABLE 2

| | | Example | Example | Example | Example | Example | Example |
|---|---|---|---|---|---|---|---|
| | | 1 | 2 | 3 | 4 | 5 | 6 |
| Composition | Polymer | Synthesis | Synthesis | Synthesis | Synthesis | Synthesis | Synthesis |
| type | | Example 1 | Example 2 | Example 3 | Example 4 | Example 5 | Example 6 |
| | Curable | TAIC | TAIC | TAIC | TAIC | TAIC | TAIC |
| | compound 1 | | | | | | |
| | Curable | | | | | | |
| | compound 2 | | | | | | |
| | Initiator | DCP | DCP | DCP | DCP | DCP | DCP |
| Composition | Polymer | 70 | 70 | 70 | 70 | 70 | 70 |
| blending | Curable | 30 | 30 | 30 | 30 | 30 | 30 |
| ratio | compound 1 | | | | | | |
| | Curable | | | | | | |
| | compound 2 | | | | | | |
| | Initiator | 0.5 | 0.5 | 0.5 | 0.5 | 0.5 | 0.5 |
| Composition | Tg(° C.) | 163 | 154 | 153 | 151 | 155 | 178 |
| properties | Peel | ◯ | ◯ | ◯ | ◯ | ◯ | ◯ |
| | strength | | | | | | |
| | Dissipation | ◯ | ◯ | ◯ | ◯ | ◯ | ◯ |
| | factor | | | | | | |
| | CTE | ◯ | ◯ | ◯ | ◯ | ◯ | ◯ |

| | | Example | Example | Example | Example | Example |
|---|---|---|---|---|---|---|
| | | 7 | 8 | 9 | 10 | 11 |
| Composition | Polymer | Synthesis | Synthesis | Synthesis | Synthesis | Synthesis |
| type | | Example 7 | Example 8 | Example 9 | Example 10 | Example 11 |
| | Curable | TAIC | TAIC | TAIC | TAIC | TAIC |
| | compound 1 | | | | | |
| | Curable | | | | | |
| | compound 2 | | | | | |
| | Initiator | DCP | DCP | DCP | DCP | DCP |
| Composition | Polymer | 70 | 70 | 70 | 70 | 70 |
| blending | Curable | 30 | 30 | 30 | 30 | 30 |
| ratio | compound 1 | | | | | |
| | Curable | | | | | |
| | compound 2 | | | | | |
| | Initiator | 0.5 | 0.5 | 0.5 | 0.5 | 0.5 |
| Composition | Tg(° C.) | 151 | 185 | 162 | 167 | 170 |
| properties | Peel | ◯ | ◯ | ◯ | ◯ | ◯ |
| | strength | | | | | |
| | Dissipation | ◯ | ◯ | ◯ | ◯ | ◯ |
| | factor | | | | | |
| | CTE | ◯ | ◯ | ◯ | ◯ | ◯ |

| | | Comparative | Comparative | Comparative | Comparative |
|---|---|---|---|---|---|
| | | Example 1 | Example 2 | Example 3 | Example 4 |
| Composition | Polymer | Synthesis | Synthesis | SA9000 | Synthesis |
| type | | Example 12 | Example 13 | | Example 14 |
| | Curable | TAIC | TAIC | TAIC | TAIC |
| | compound 1 | | | | |
| | Curable | | | | |
| | compound 2 | | | | |
| | Initiator | DCP | DCP | DCP | DCP |
| Composition | Polymer | 70 | 70 | 70 | 70 |
| blending | Curable | 30 | 30 | 30 | 30 |
| ratio | compound 1 | | | | |
| | Curable | | | | |
| | compound 2 | | | | |
| | Initiator | 0.5 | 0.5 | 0.5 | 0.5 |
| Composition | Tg(° C.) | 135 | 129 | 165 | 181 |
| properties | Peel | ◯ | ◯ | X | X |
| | strength | | | | |
| | Dissipation | ◯ | ◯ | X | X |
| | factor | | | | |
| | CTE | X | X | X | ◯ |

| | | Example | Example | Example | Example | Example | Example |
|---|---|---|---|---|---|---|---|
| | | 12 | 13 | 14 | 15 | 16 | 17 |
| Composition | Polymer | Synthesis | Synthesis | Synthesis | Synthesis | Synthesis | Synthesis |
| type | | Example 1 | Example 2 | Example 3 | Example 4 | Example 5 | Example 6 |
| | Curable | | | | | | |
| | compound | | | | | | |
| | 1 | | | | | | |
| | Curable | DVB960 | DVB960 | DVB960 | DVB960 | DVB960 | DVB960 |
| | compound | | | | | | |
| | 2 | | | | | | |
| | Initiator | DCP | DCP | DCP | DCP | DCP | DCP |
| Composition | Polymer | 70 | 70 | 70 | 70 | 70 | 70 |
| blending | Curable | | | | | | |
| ratio | compound | | | | | | |
| | 1 | | | | | | |
| | Curable | 30 | 30 | 30 | 30 | 30 | 30 |
| | compound | | | | | | |
| | 2 | | | | | | |
| | Initiator | 0.5 | 0.5 | 0.5 | 0.5 | 0.5 | 0.5 |
| Composition | Tg(° C.) | 184 | 175 | 171 | 170 | 173 | 194 |
| properties | Peel | ◯ | ◯ | ◯ | ◯ | ◯ | ◯ |
| | strength | | | | | | |
| | Dissipation | ◯ | ◯ | ◯ | ◯ | ◯ | ◯ |
| | factor | | | | | | |
| | CTE | ◯ | ◯ | ◯ | ◯ | ◯ | ◯ |

| | | Example | Example | Example | Example | Example | Example |
|---|---|---|---|---|---|---|---|
| | | 18 | 19 | 20 | 21 | 22 | 23 |
| Composition | Polymer | Synthesis | Synthesis | Synthesis | Synthesis | Synthesis | Synthesis |
| type | | Example 7 | Example 8 | Example 9 | Example 10 | Example 11 | Example 15 |
| | Curable | | | | | | |
| | compound | | | | | | |
| | 1 | | | | | | |
| | Curable | DVB960 | DVB960 | DVB960 | DVB960 | DVB960 | DVB960 |
| | compound | | | | | | |
| | 2 | | | | | | |
| | Initiator | DCP | DCP | DCP | DCP | DCP | DCP |
| Composition | Polymer | 70 | 70 | 70 | 70 | 70 | 70 |
| blending | Curable | | | | | | |
| ratio | compound | | | | | | |
| | 1 | | | | | | |
| | Curable | 30 | 30 | 30 | 30 | 30 | 30 |
| | compound | | | | | | |
| | 2 | | | | | | |
| | Initiator | 0.5 | 0.5 | 0.5 | 0.5 | 0.5 | 0.5 |
| Composition | Tg(° C.) | 167 | 195 | 182 | 188 | 190 | 200 |
| properties | Peel | ◯ | ◯ | ◯ | ◯ | ◯ | ◯ |
| | strength | | | | | | |
| | Dissipation | ◯ | ◯ | ◯ | ◯ | ◯ | ◯ |
| | factor | | | | | | |
| | CTE | ◯ | ◯ | ◯ | ◯ | ◯ | ◯ |

| | | Comparative | Comparative | Comparative | Comparative |
|---|---|---|---|---|---|
| | | Example 5 | Example 6 | Example 7 | Example 8 |
| Composition | Polymer | Synthesis | Synthesis | SA9000 | Synthesis |
| type | | Example 12 | Example 13 | | Example 14 |
| | Curable | | | | |
| | compound | | | | |
| | 1 | | | | |
| | Curable | DVB960 | DVB960 | DVB960 | DVB960 |
| | compound | | | | |
| | 2 | | | | |
| | Initiator | DCP | DCP | DCP | DCP |
| Composition | Polymer | 70 | 70 | 70 | 70 |
| blending | Curable | | | | |
| ratio | compound | | | | |
| | 1 | | | | |
| | Curable | 30 | 30 | 30 | 30 |
| | compound | | | | |
| | 2 | | | | |
| | Initiator | 0.5 | 0.5 | 0.5 | 0.5 |
| Composition | Tg(° C.) | 155 | 151 | 175 | 196 |
| properties | Peel | ◯ | ◯ | X | X |
| | strength | | | | |
| | Dissipation | ◯ | ◯ | X | X |
| | factor | | | | |
| | CTE | X | X | X | ◯ |

Abbreviations used in Tables 1 and 2 will be described below.

### <Polymer>

SA-9000: manufactured by SABIC, terminal-modified polyphenylene ether

### <Curable Compound>

TAIC: triallyl isocyanurate, manufactured by Mitsubishi Chemical Corporation
DVB960: divinylbenzene (divinylbenzene: 96 mass %), manufactured by NIPPON STEEL Chemical & Material Co., Ltd.

### <Initiator>

DCP: dicumyl peroxide, PERCUMYL D, manufactured by NOE CORPORATION

1. A polymer (A) comprising having a repeating structural unit represented by formula (1): 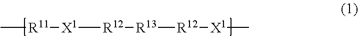
wherein, in the formula (1),
R¹¹ represents a divalent substituted or unsubstituted nitrogen-containing heteroaromatic ring,
R¹²'s independently represent a divalent substituted or unsubstituted aromatic hydrocarbon group,
R¹³ represents a hydrocarbon group having 1 to 20 carbon atoms to which at least one group represented by formula (a1) is bonded in addition to two R¹²'s,
X¹'s independently represent —O—, —S—, or —N(R¹⁴)—, and
R¹⁴ is a hydrogen atom, a monovalent hydrocarbon group having 1 to 20 carbon atoms, a monovalent halogenated hydrocarbon group having 1 to 20 carbon atoms, or a group in which the hydrocarbon group or the halogenated hydrocarbon group is partially substituted with an oxygen atom, a sulfur atom, or both, 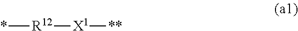
wherein, in the formula (a1),
* represents a linkage to the R¹³,
** represents a bond to another structural unit in the polymer (A), and
R¹² and X¹ are each as defined in the formula (1), respectively.

2. The polymer (A) according to claim 1, further comprising a repeating structural unit represented by formula (2): 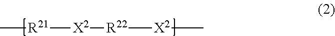
wherein, in the formula (2),
R²¹ represents a divalent substituted or unsubstituted nitrogen-containing heteroaromatic ring,
R²² represents a divalent group containing a substituted or unsubstituted aromatic hydrocarbon group in a main chain,
X²'s independently represent —O—, —S—, or —N(R²⁴)—, and
R²⁴ is a hydrogen atom, a monovalent hydrocarbon group having 1 to 20 carbon atoms, a monovalent halogenated hydrocarbon group having 1 to 20 carbon atoms, or a group in which the hydrocarbon group or the halogenated hydrocarbon group is partially substituted with an oxygen atom, a sulfur atom, or both.

3. The polymer (A) according to claim 1, further comprising a group Y represented by formula (y) at a terminal thereof: 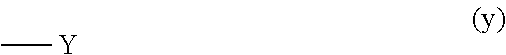
wherein, in the formula (y), Y represents a group containing an ethylenically unsaturated double bond and having 3 to 50 carbon atoms, a substituted or unsubstituted aromatic hydrocarbon group having 6 to 50 carbon atoms, a substituted or unsubstituted aliphatic hydrocarbon group having 6 to 50 carbon atoms, or an unsubstituted nitrogen-containing heteroaromatic ring.

4. The polymer (A) according to claim 1, wherein when all structural units contained in the polymer (A) are taken as 100 mol %, the repeating structural unit represented by the formula (1) is contained in the polymer (A) in a range of 5 mol % or more and 95 mol % or less.

5. The polymer (A) according to claim 1, wherein —R¹²-'s in the formulae (1) and (a1) are independently a structure represented by formula (5): 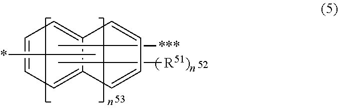
wherein, in the formula (5),
* represents a linkage to the R¹³,
*** represents a bond to the X¹, and
R⁵¹ represents an alkyl group having 1 to 10 carbon atoms, an alkoxy group having 1 to 10 carbon atoms, or a cycloalkyl group having 3 to 10 carbon atoms, n⁵² represents an integer of 0 to 4, and n⁵³ represents an integer of 0 to 2.

6. The polymer (A) according to claim 5, wherein the structure represented by the formula (5) is formula (5-1) or formula (5-2): 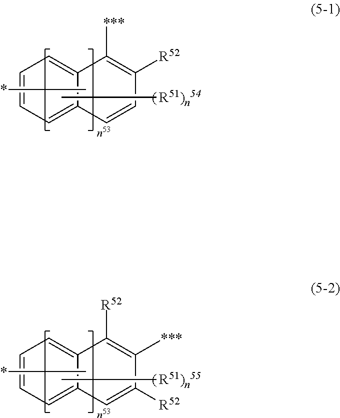
wherein, in the formulae (5-1) and (5-2),
* represents a linkage to the R¹³,
*** represents a bond to the X¹,
R⁵¹ and n⁵³ are each as defined in the formula (5),
n⁵⁴ represents an integer of 0 to 3, and n⁵⁵ represents an integer of 0 to 2; and
R⁵² represents an alkyl group having 1 to 10 carbon atoms, an alkoxy group having 1 to 10 carbon atoms, or a cycloalkyl group having 3 to 10 carbon atoms.

7. A composition comprising; the polymer (A) according to claim 1; and a curable compound (B) other than the polymer (A).

8. The composition according to claim 7, wherein the curable compound (B) comprises at least one selected from the group consisting of a vinyl compound, a maleimide compound, an allyl compound, an acrylic compound, a methacrylic compound, a thiol compound, an oxazine compound, a cyanate compound, an epoxy compound, an oxetane compound, a methylol compound, a benzocyclobutene compound, a propargyl compound, and a silane compound.

9. The composition according to claim 7, further comprising at least one selected from the group consisting of a hindered phenolic compound, a phosphorus-based compound, a sulfur-based compound, a metal-based compound, and a hindered amine-based compound.

10. A composition comprising a polymer (A2) comprising: a repeating structural unit represented by formula (3) and a repeating structural unit represented by formula (4); and a curable compound (B2) other than the polymer (A2): 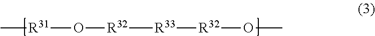
wherein, in the formula (3),
R³¹ represents a divalent organic group having 3 to 10 carbon atoms,
R³²'s independently represent a divalent substituted or unsubstituted aromatic hydrocarbon group, and
R³³ represents a hydrocarbon group having 1 to 20 carbon atoms to which two R³²'s and at least one group represented by formula (a2) are bonded, 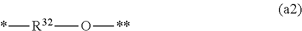
wherein, in the formula (a2),
* represents a linkage to the R³³,
** represents a bond to another structural unit in the polymer (A2), and
R³² is as defined in the formula (3), 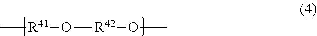
wherein, in the formula (4),
R⁴¹ represents a divalent organic group having 3 to 10 carbon atoms, and
R⁴² represents a divalent group comprising a substituted or unsubstituted aromatic hydrocarbon group in a main chain, and the oxygen atom in the formula (4) is directly bonded to the aromatic hydrocarbon group.

11. The composition according to claim 10, wherein the polymer (A2) comprises a group Y represented by formula (y) at a terminal thereof: 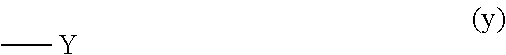
wherein, in the formula (y), Y represents a group comprising an ethylenically unsaturated double bond and having 3 to 50 carbon atoms, a substituted or unsubstituted aromatic hydrocarbon group having 6 to 50 carbon atoms, a substituted or unsubstituted aliphatic hydrocarbon group having 6 to 50 carbon atoms, or an unsubstituted nitrogen-containing heteroaromatic ring.

12. The composition according to claim 10, wherein the curable compound (B2) comprises at least one selected from the group consisting of a vinyl compound, a maleimide compound, an allyl compound, an acrylic compound, a methacrylic compound, a thiol compound, an oxazine compound, a cyanate compound, an epoxy compound, an oxetane compound, a methylol compound, a benzocyclobutene compound, a propargyl compound, and a silane compound.

13. The composition according to claim 10, further comprising an antioxidant.

14. A cured product which is a cured body of the composition according to claim 7.

15. A laminated body comprising a substrate and a cured product layer formed by curing the composition according to claim 7.

16. An electronic component comprising the cured product according to claim 14.

17. An electronic component comprising the laminated body according to claim 15.
